(19) United States
(12) Patent Application Publication
(10) Pub. No.: US 2015/0058502 A1
(43) Pub. Date: Feb. 26, 2015

(54) I/O DEVICE, PROGRAMMABLE LOGIC CONTROLLER, AND OPERATION METHOD

(71) Applicant: MITSUBISHI ELECTRIC CORPORATION, Chiyoda-ku, Tokyo (JP)

(72) Inventors: Seiji Seki, Chiyoda-ku (JP); Takahiko Masuzaki, Chiyoda-ku (JP)

(73) Assignee: MITSUBISHI ELECTRIC CORPORATION, Chiyoda-ku, Tokyo (JP)

(21) Appl. No.: 14/381,424

(22) PCT Filed: May 21, 2013
(86) PCT No.: PCT/JP2013/064120

§ 371 Date: Aug. 27, 2014

(30) Foreign Application Priority Data
Jun. 14, 2012 (JP) PCT/JP2012/065207

(51) Int. Cl. G06F 13/10; G06F 13/20

(52) U.S. Cl. CPC G06F 13/10; G06F 13/20
USPC 710/19

(57) ABSTRACT

A device and method allowing input/output processing of a plurality of data to be processed in parallel at each I/O device of a PLC. An operation data extraction unit of each I/O device inputs a received different station's input of one of the other I/O devices and a received different station's output of one of the other I/O devices, and also inputs an own station's input and an own station's output. The operation data extraction unit extracts operation data from each of the own station's input and output, and the different station's input and output, according to parameters (which specify a selected type, a data position, a selected station number, and an own station number) stored in a parameter unit. An operation unit executes a plurality of operation processing in parallel by using the operation data extracted by the operation data extraction unit and according to operation processing.

### TECHNICAL FIELD

The present invention relates to an I/O device used in a programmable logic controller.

### BACKGROUND ART

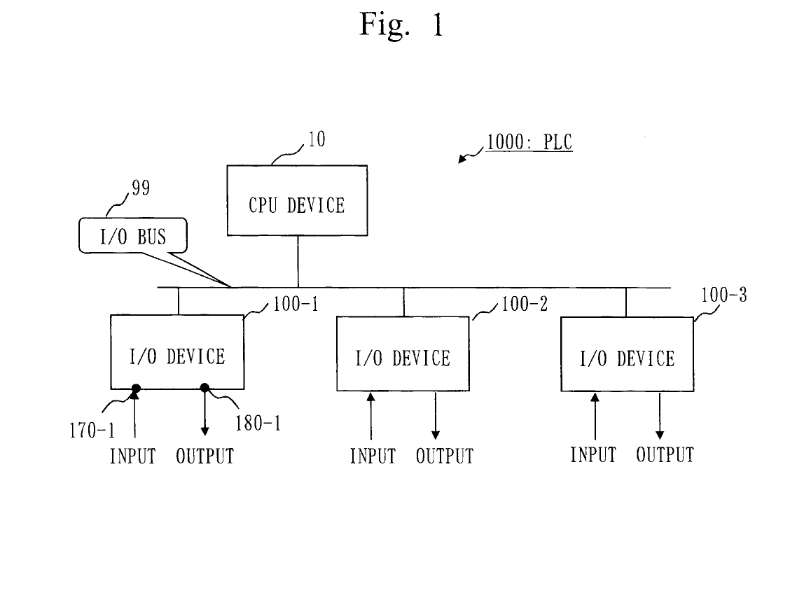

FIG. 1 shows a PLC 1000 (programmable logic controller) in which a CPU device 10 and a plurality of (three) I/O devices are connected by an I/O bus 99. Three I/O devices 100-1 to 100-3 are connected to the CPU device 10, and the three I/O devices have a same configuration. In conventional input/output processing among the I/O devices in the PLC 1000 connected as in FIG. 1, the CPU device 10 first collects (inputs) “input terminal information” of each I/O device. The “input terminal information” is herein information input to an input terminal 170-1 of each I/O device. The CPU device 10 performs operation processing using the collected “input terminal information”, and delivers (outputs) an operation result of the operation processing to one of the I/O devices. The operation result to be delivered indicates, to which I/O device, the operation result that has been obtained is to be delivered, for example. Then, the I/O device to which the operation result of its own has been delivered outputs the operation result to an output terminal 180-1. The CPU device 10 performs this input/output processing for every I/O device and repeats this input/output processing.

There is a problem that an I/O processing response is delayed because the CPU device 10 processes the input/output processing for every I/O device in a concentrated manner. In order to address this problem, JP 1995-244506 (Patent Literature 1) describes a method of reducing a processing burden on the CPU device 10. Further, JP 2000-259208 (Patent Literature 2) describes a processing method in which the input/output processing is performed at each I/O device not via the CPU device 10.

In Patent Literature 1, a “common memory” is provided for each I/O device, and input terminal information of each I/O device is moved between the common memories not via the CPU device 10. A processing burden on the CPU device 10 is thereby reduced. However, since it is so configured that the input terminal information is temporarily stored in the common memory, a plurality of data cannot be read all at once from the memory when input/output processing among a plurality of the I/O devices is performed. For this reason, the input/output processing cannot be processed in parallel, so that it takes time to perform the processing. Further, the input terminal information of each I/O device is all stored in the common memory. Thus, even data which is not to be used for the input/output processing among the I/O devices may be stored. Thus, as the number of the I/O devices increases, implementation of the memories is performed more than necessary.

In Patent Literature 2, a connection database and an MPU are provided. The connection database stores a mapping table configured to associate information on the own I/O device and each of the other I/O devices. The MPU processes data based on the mapping table stored in the connection database. Input terminal information of each I/O device is transmitted and received among the respective I/O devices. Input/output processing is performed at each I/O device not via the CPU device 10. However, since the MPU refers to the mapping table stored in the connection database for each connection data upon receipt of the input terminal information, a plurality of data cannot be referred to all at once, so that input/output processing cannot be processed in parallel. Further, it is so configured that when operation processing is performed on the input terminal information, working data is stored in a memory and the MPU thereby performs the operation processing. Thus, the plurality of data cannot be processed in parallel, so that it takes time to perform the processing. The MPU and the memory are needed for performing the input/output processing among the I/O devices. Thus, the processing method described in Patent Literature 2 costs high.

A delay may be desirably added to delay an output timing of an output of the I/O device in the PLC, or the output of the I/O device in the PLC may be desirably continued to be output while the value of the output of the I/O device is held. Addition of the delay may be used in a case, where when an operation based on an input is executed, the result of the operation is not desired to be notified to an outside until certain processing (such as save processing) is completed. Holding of the output value may be used in a case where, when the operation is executed, notification of the output value to the outside is desired to be continued until certain processing (such as the save processing) is completed.

Patent Literature 3 discloses that an input/output between each I/O device and each of sensor or the like is held in a database and an output is provided at a timing defined in a table in order to speed up and streamline data transfer. Patent Literature 3, however, does not disclose addition of a delay, output value holding, and sequentially delaying each operation result so as to execute continuous operations of performing stop processing according to the emergency stop order of a plurality of devices after input of an emergency error signal of one of the devices. Further, the input/output device disclosed in Patent Literature 3 is a system using the database. Thus, Patent Literature 3 discloses sequential processing of checking whether or not an output suited to an output timing condition is present by repetition of measurement of a period of time, referring to the corresponding table, and referring to the database for each output. For this reason, there is a problem that a precise output timing cannot be implemented with the method disclosed in Patent Literature 3. Further, since the input/output device is the system using the database. Thus, there is a problem that the circuit size increases.

### CITATION LIST

### Patent Literature

Patent Literature 1: JP 1995-244506

Patent Literature 2: JP 2000-259208

Patent Literature 3: JP 2010-231407

### SUMMARY OF INVENTION

### Technical Problem

In the conventional method of performing input/output processing among the I/O devices not via the CPU device 10, when input terminal information of each I/O device is transmitted and received among the respective I/O devices, the input terminal information of each I/O device is temporarily stored in the memory (as described in Patent Literature 1). Alternatively, the MPU refers to the mapping table stored in the connection database for each connection data upon receipt of the input terminal information (as described in Patent Literature 2). For that reason, there is a problem that input/output processing of a plurality of data cannot be performed in parallel, so that it takes time to perform the processing. There is also a problem that memory implementation is performed more than necessary, so that the processing method costs high because the MPU is needed.

An object of the present invention is to allow input/output processing of a plurality of data to be processed in parallel at each I/O device, without providing in each I/O device a memory for storing input terminal information or an MPU, thereby achieving speeding-up of input/output processing among the I/O devices at low cost.

### Solution to Problem

An I/O (Input/Output) device of the present invention is an I/O device to be used in a programmable logic controller including a CPU (Central Processing Unit) device and a plurality of the I/O devices. The I/O device may include:

an interface unit which communicates with the CPU device and also communicates with the other I/O devices, the interface unit receiving from each of the other I/O devices input information input to the other I/O device and output information output from the other I/O device;

a parameter unit which stores methods of a plurality of operation processing and a parameter indicating an extraction condition for extracting operation data to be used for the operation processing;

an operation data extraction unit which inputs the input information and the output information of each of the other I/O devices received by the interface unit and also inputs input information input into the own I/O device and output information output from the own I/O device, extracts the operation data from each of the input information and the output information of the other I/O devices which have been input and the input information and the output information of the own I/O device which have been input, according to the parameter stored in the parameter unit, and outputs the extracted operation data; and

an operation unit which executes the plurality of operation processing in parallel, by using the operation data output by the operation data extraction unit and according to the methods of the plurality of operation processing stored in the parameter unit.

### Advantageous Effects of Invention

The invention allows input/output processing of a plurality of data to be processed in parallel at each I/O device of a PLC, thereby achieving speeding-up of input/output processing among the I/O devices at low cost.

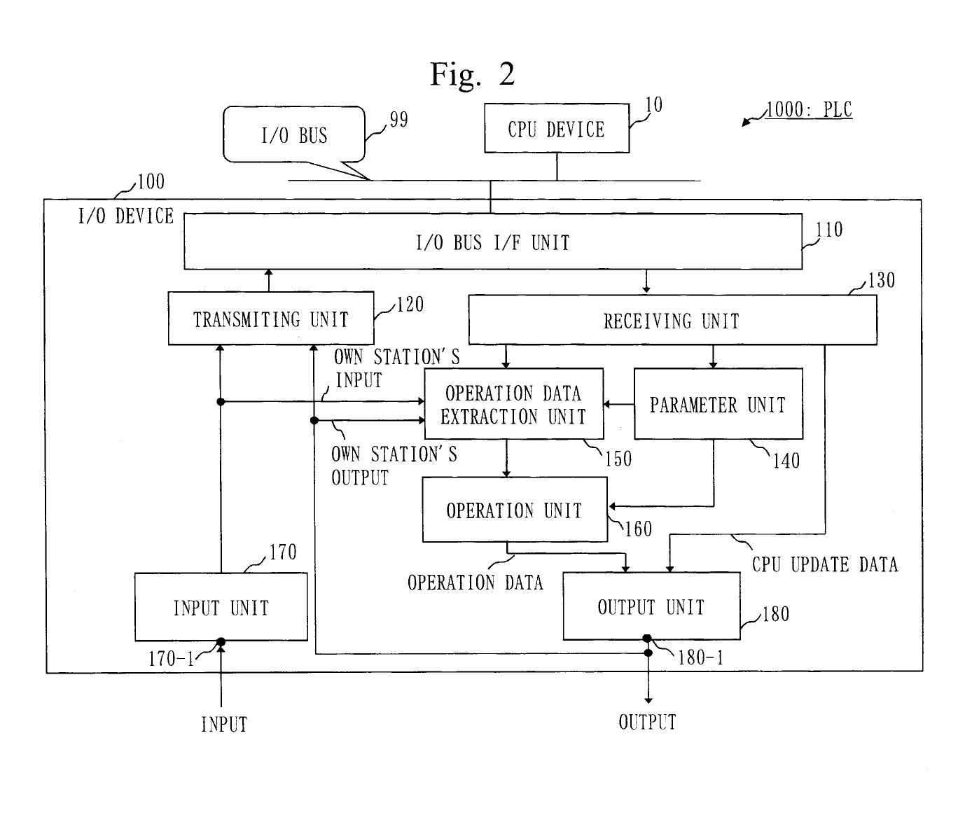

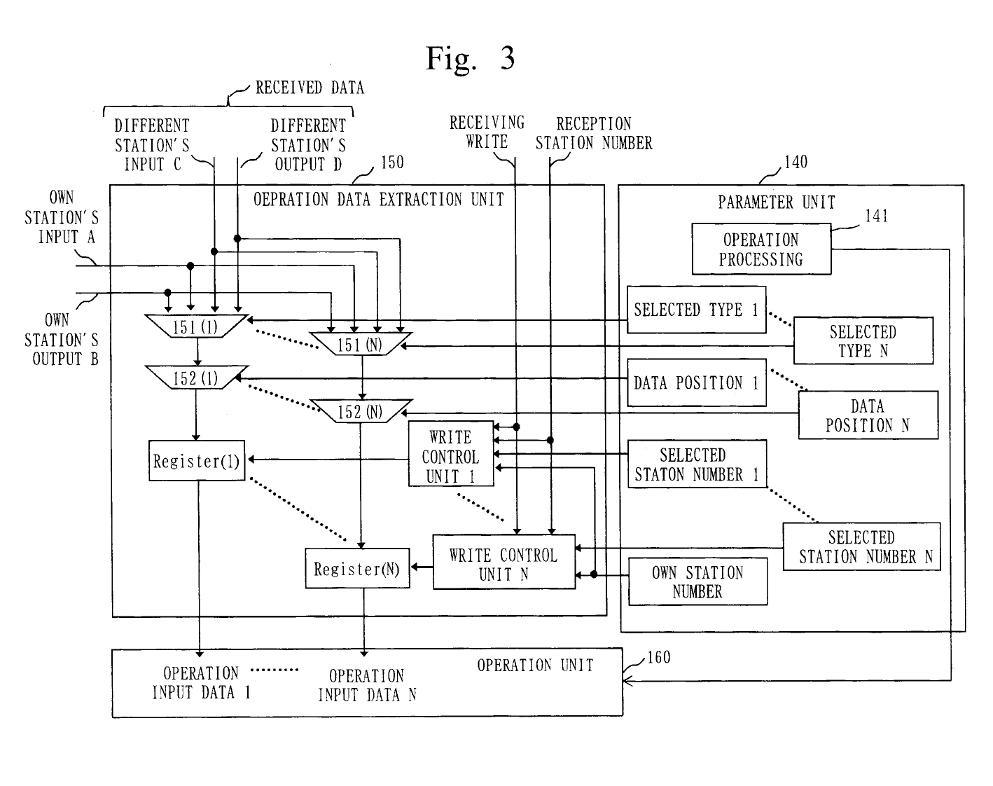

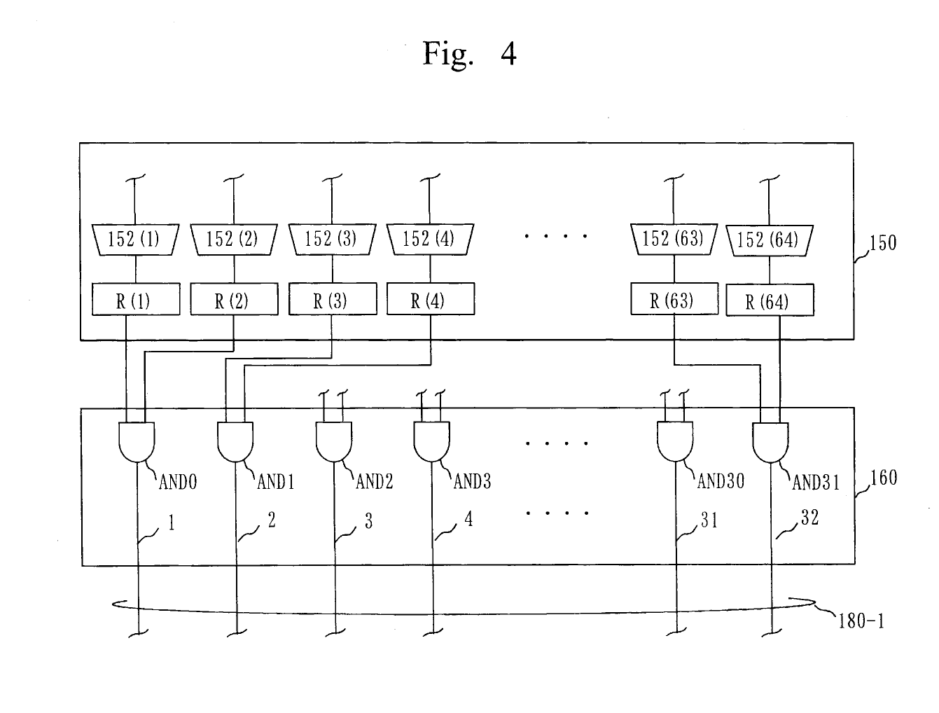

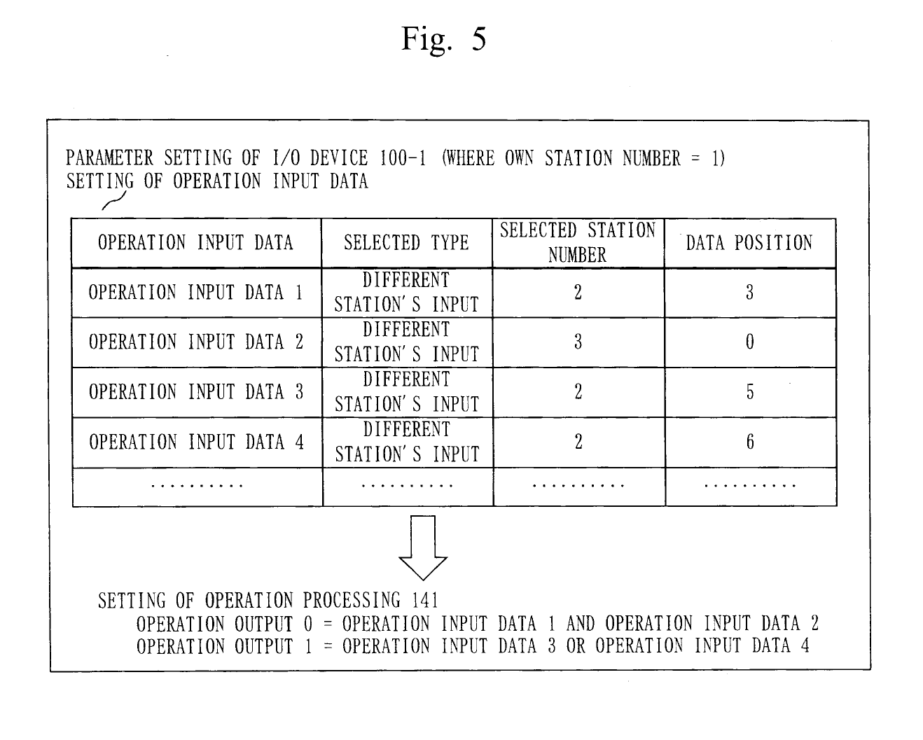

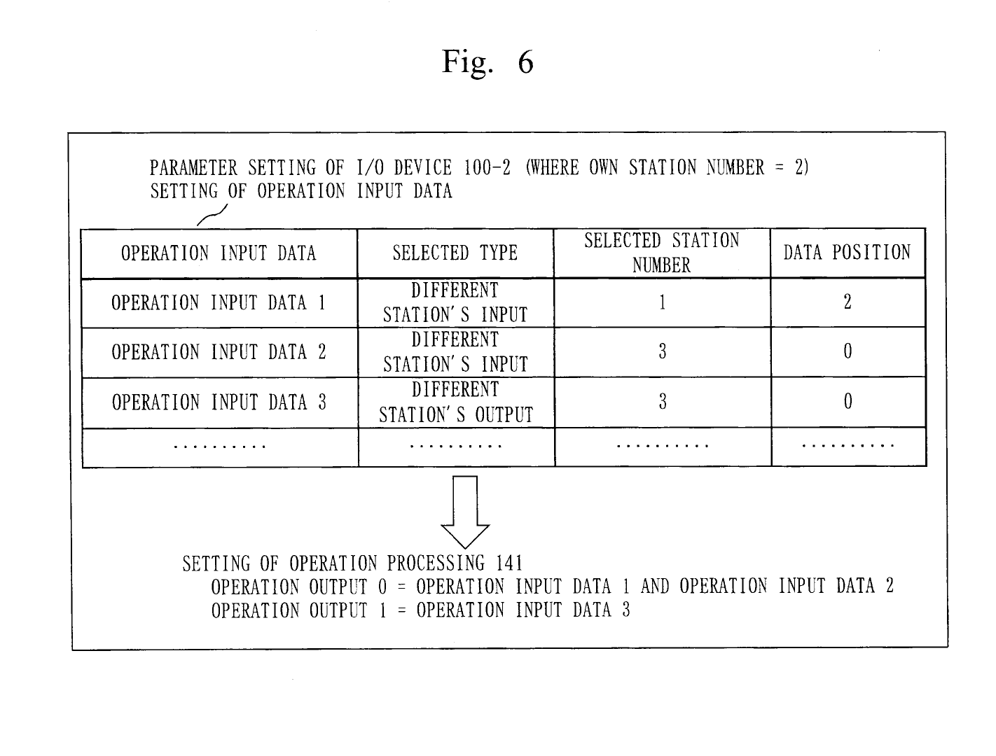

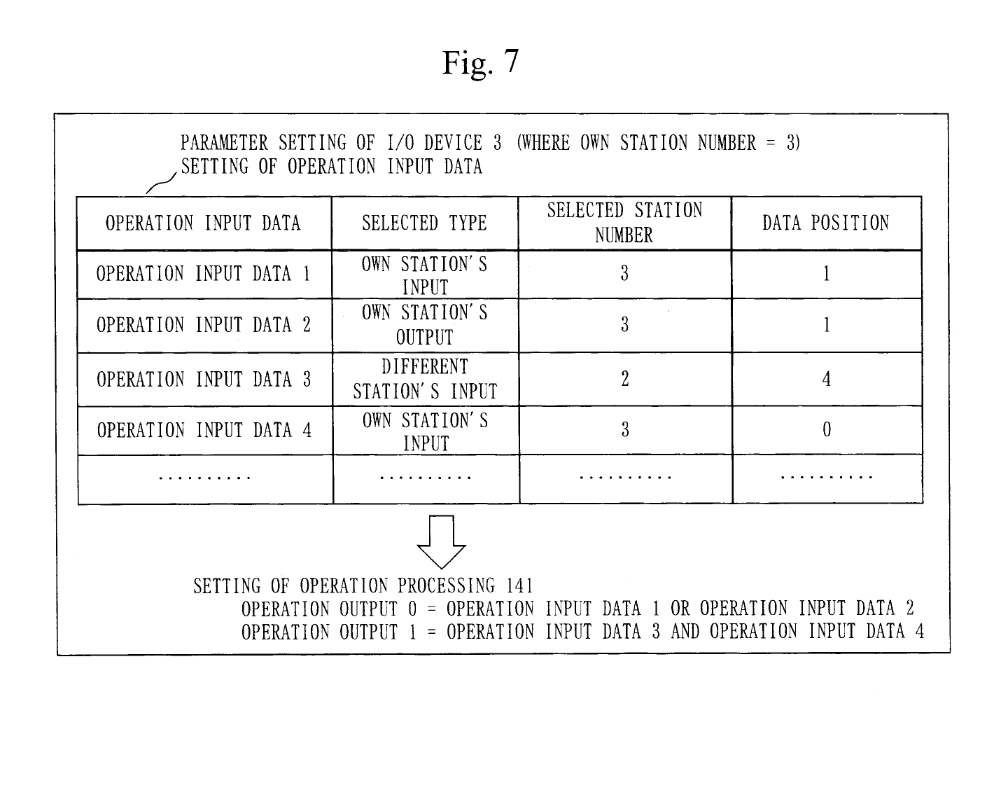

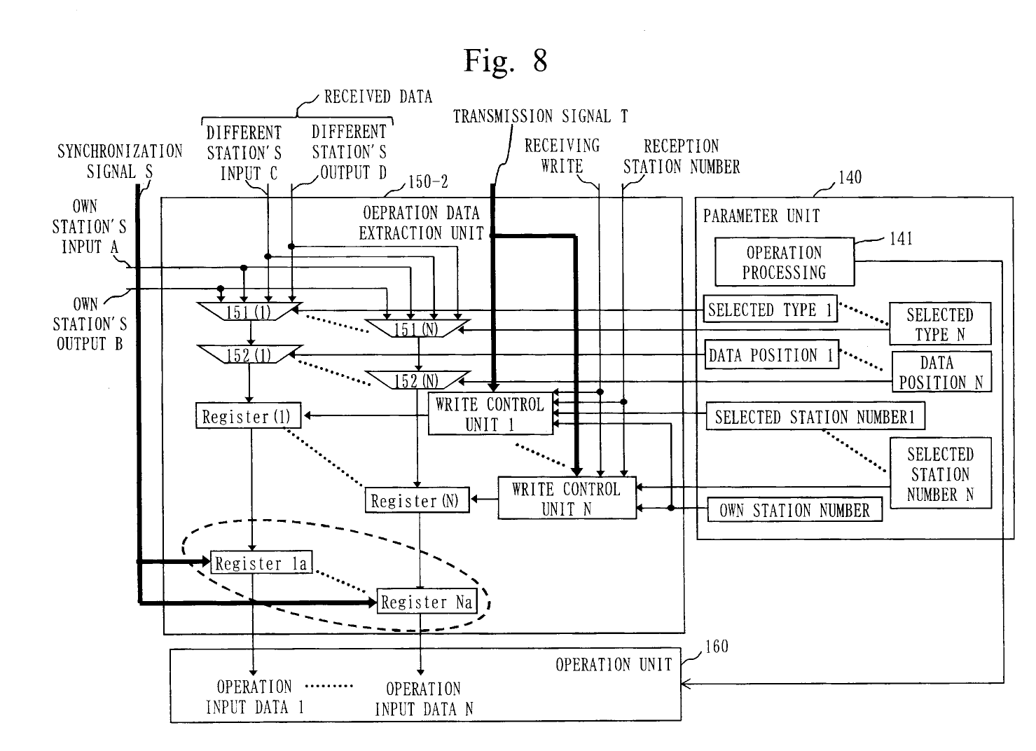

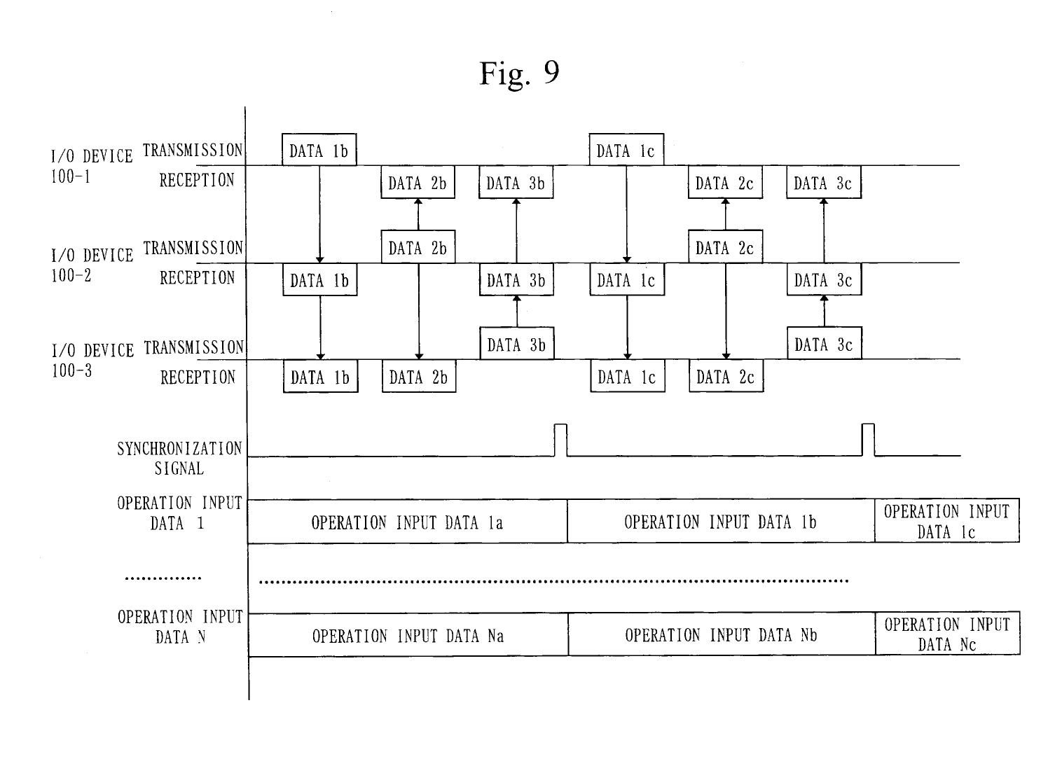

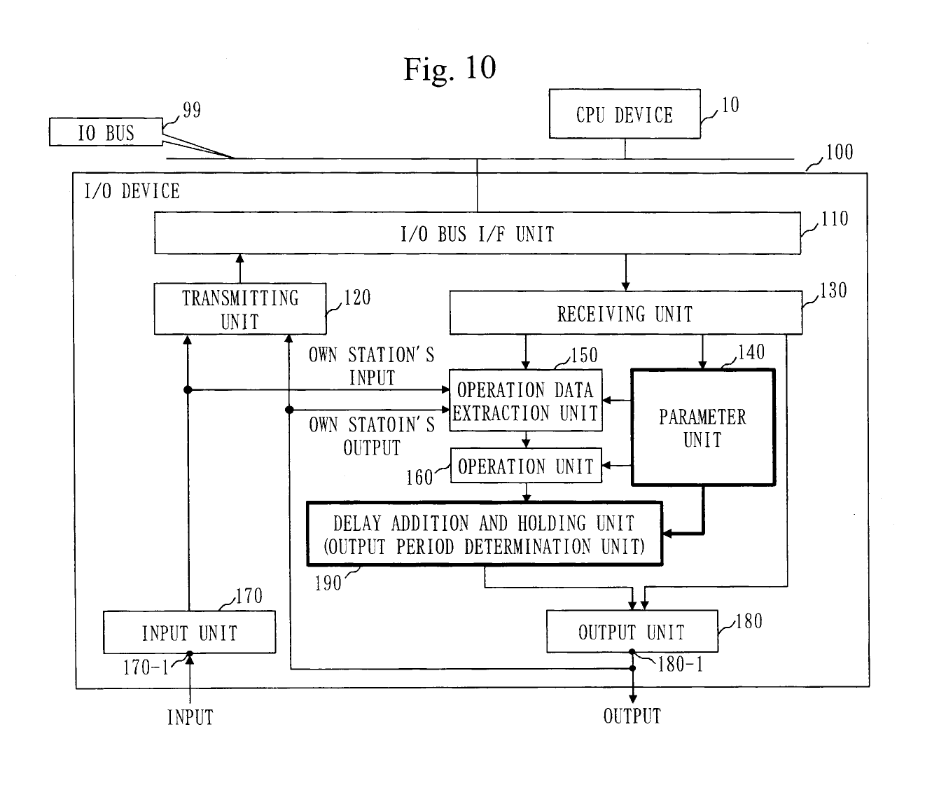

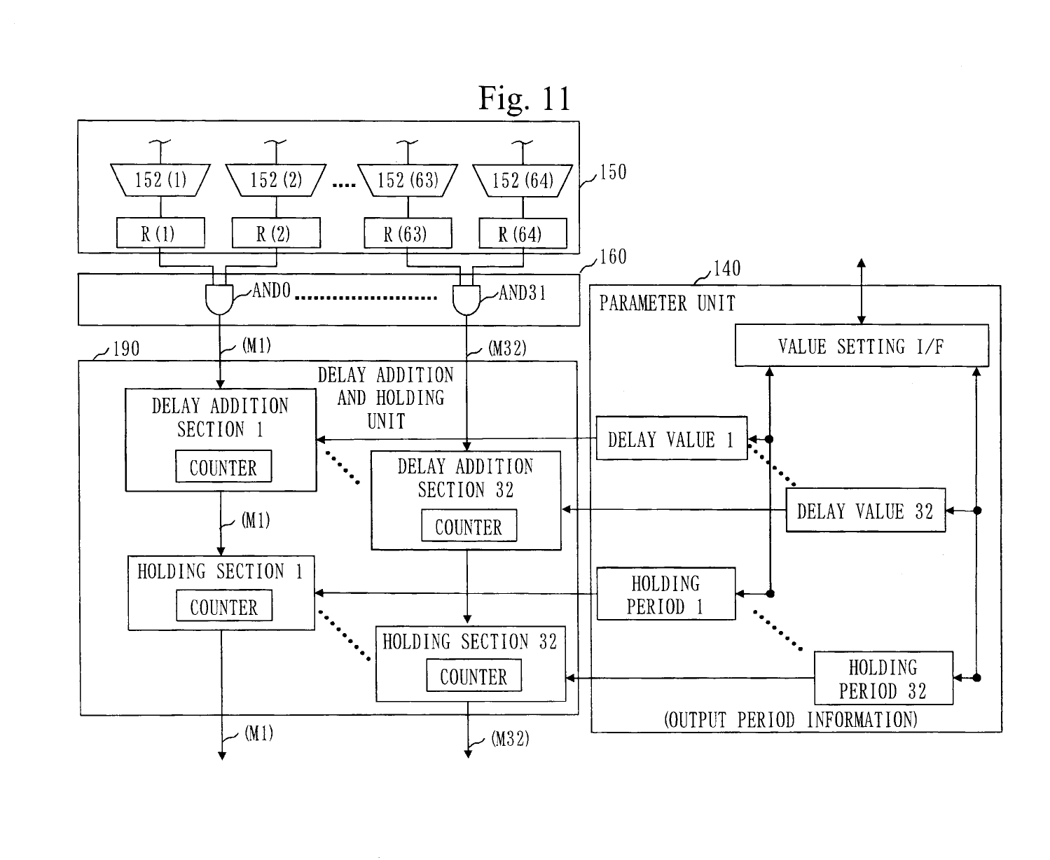

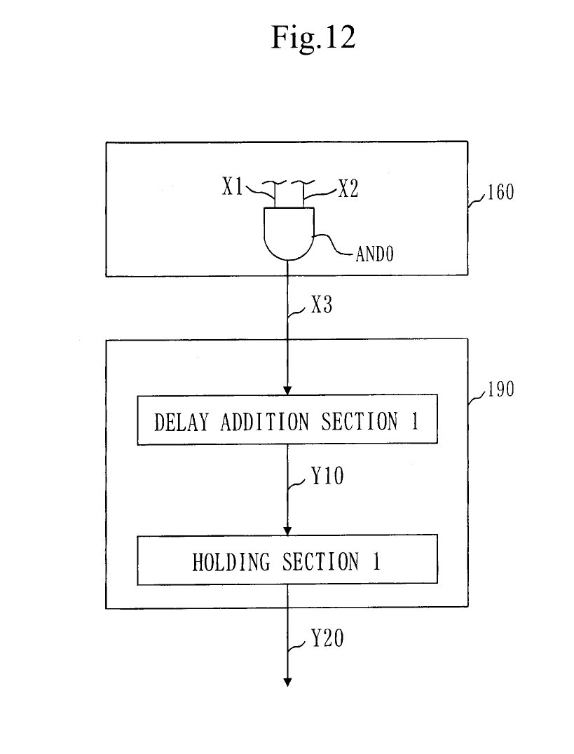

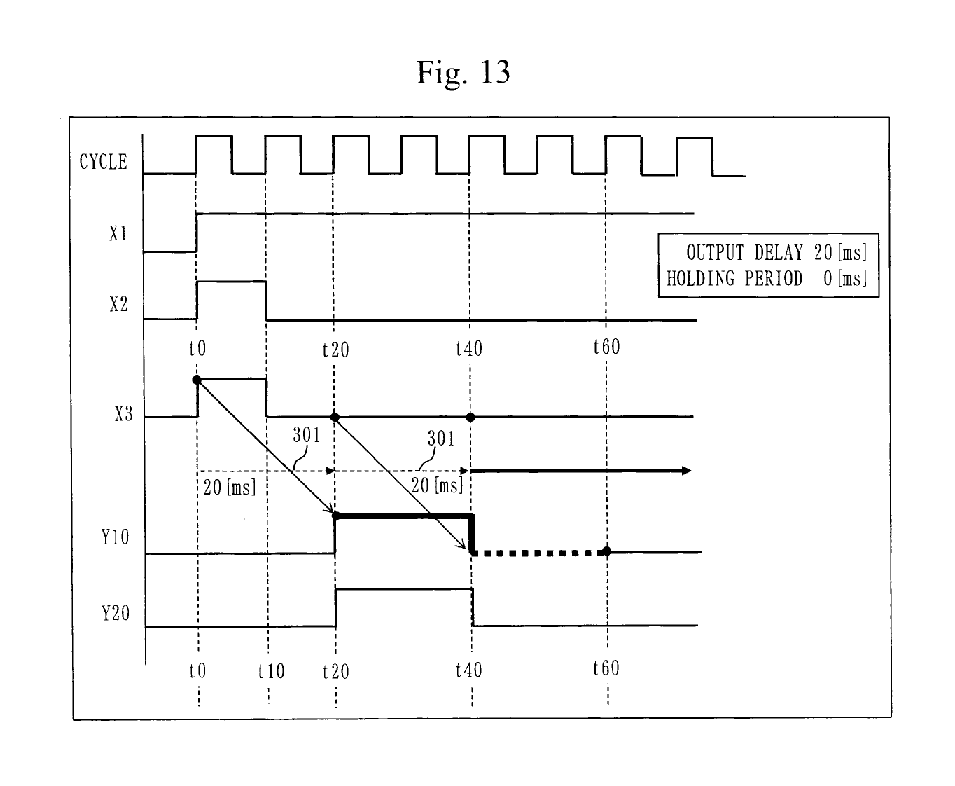

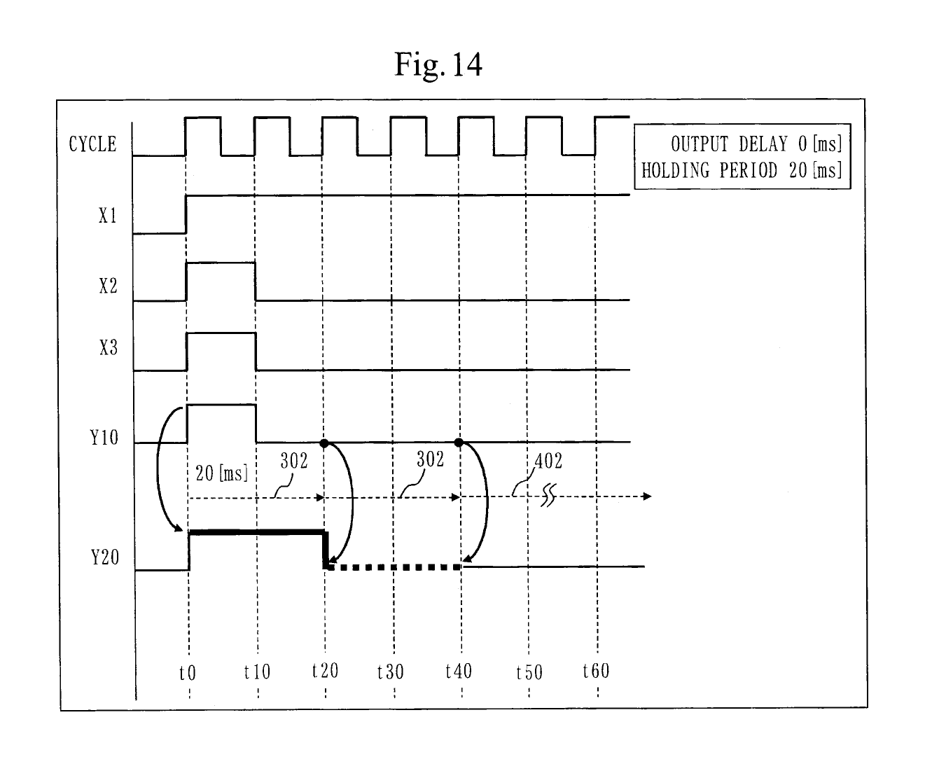

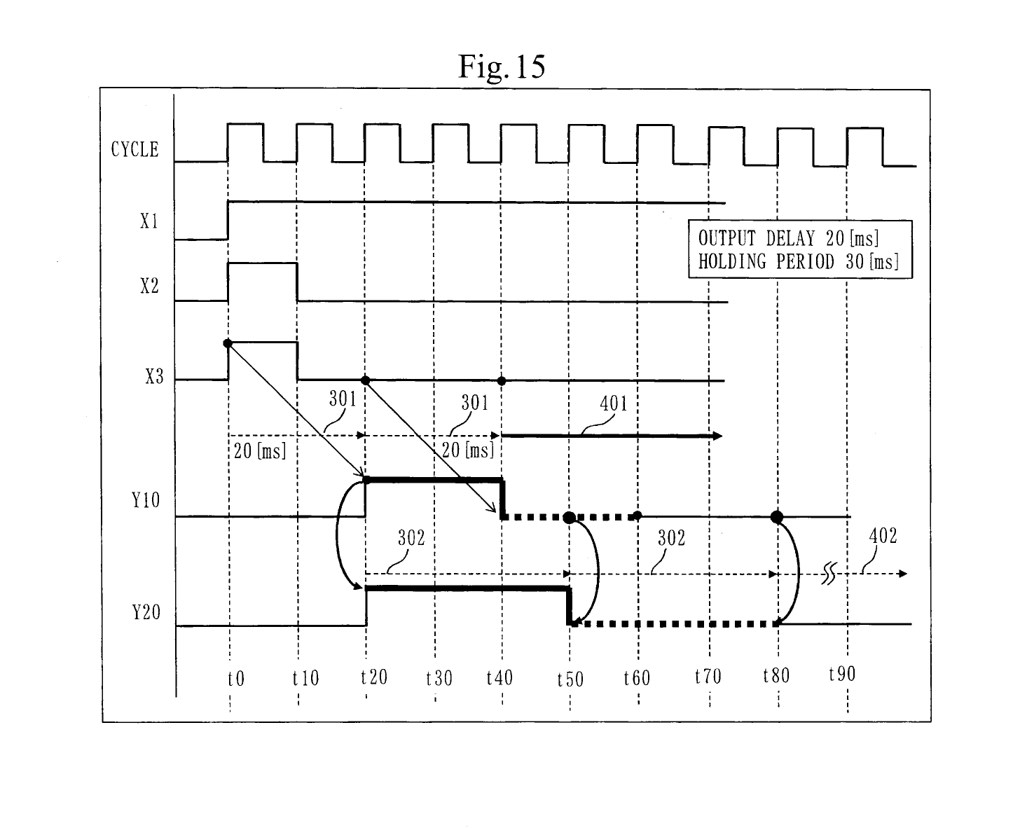

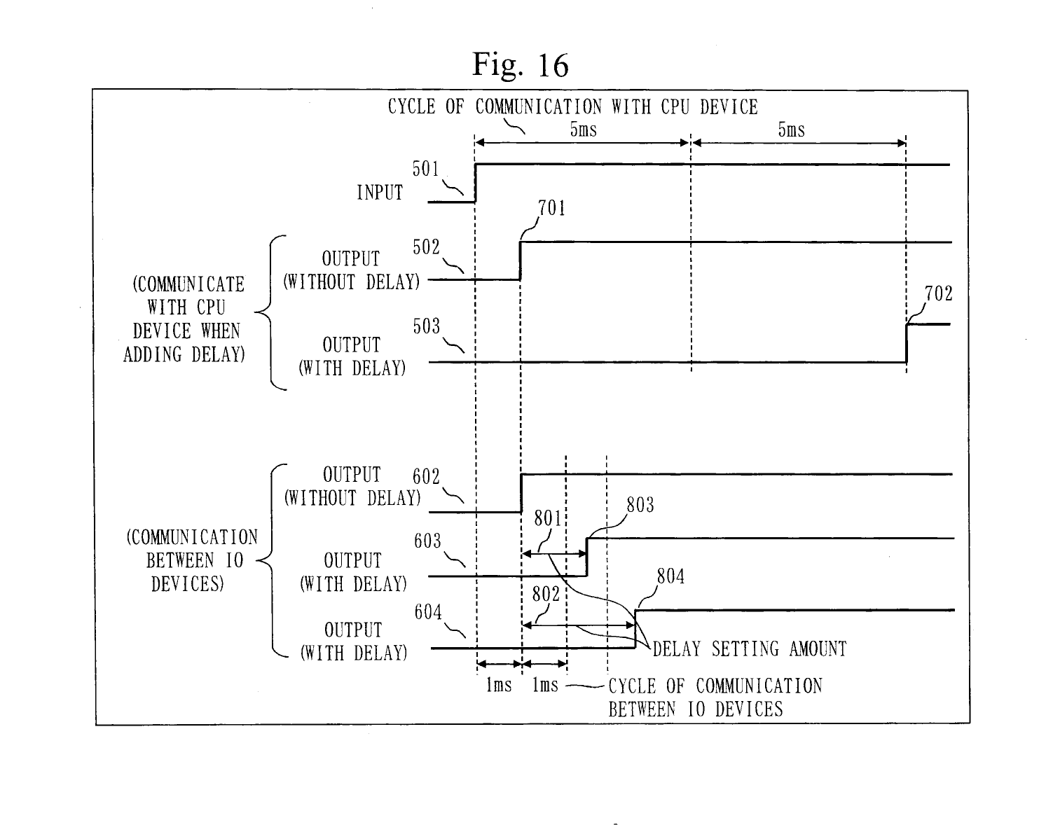

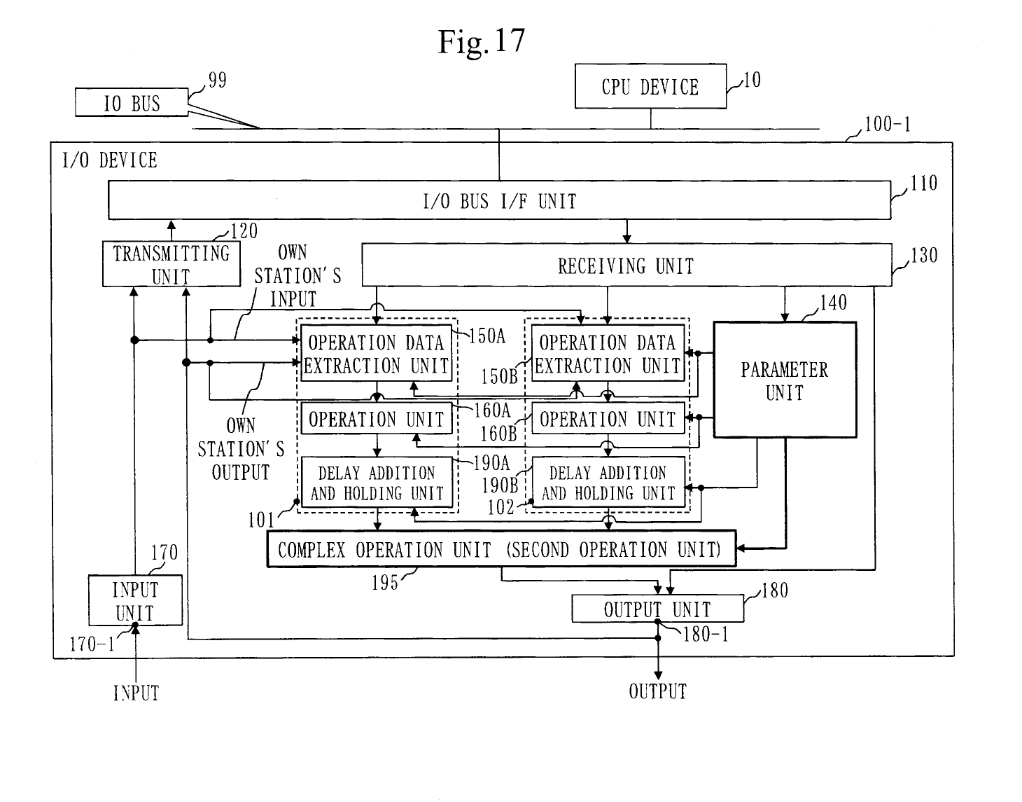

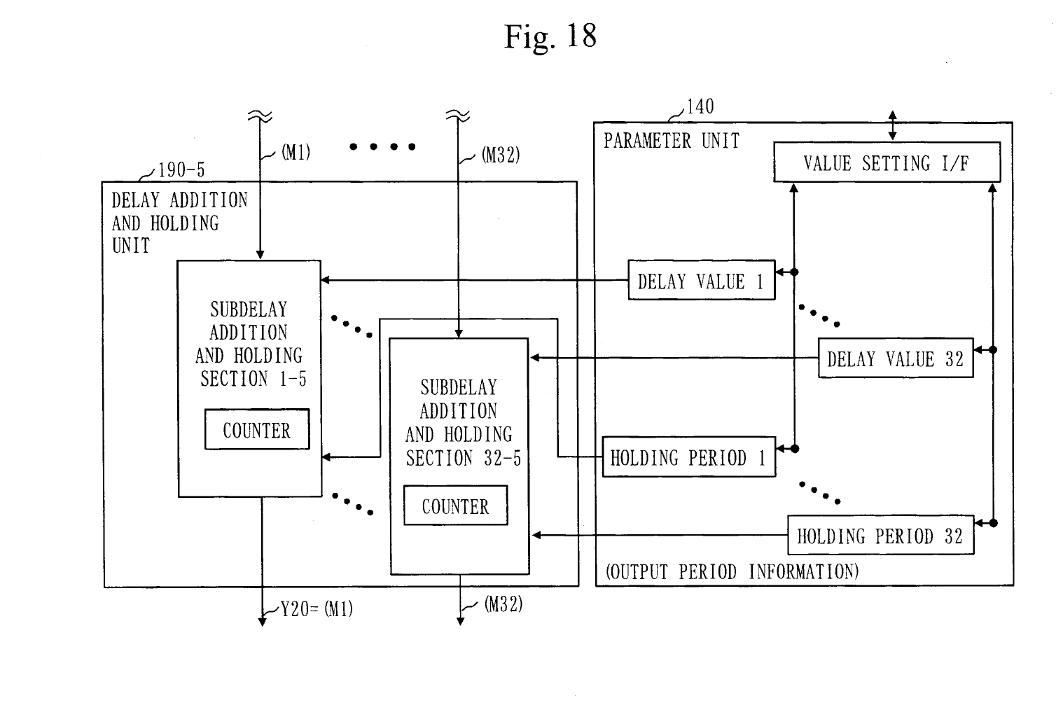

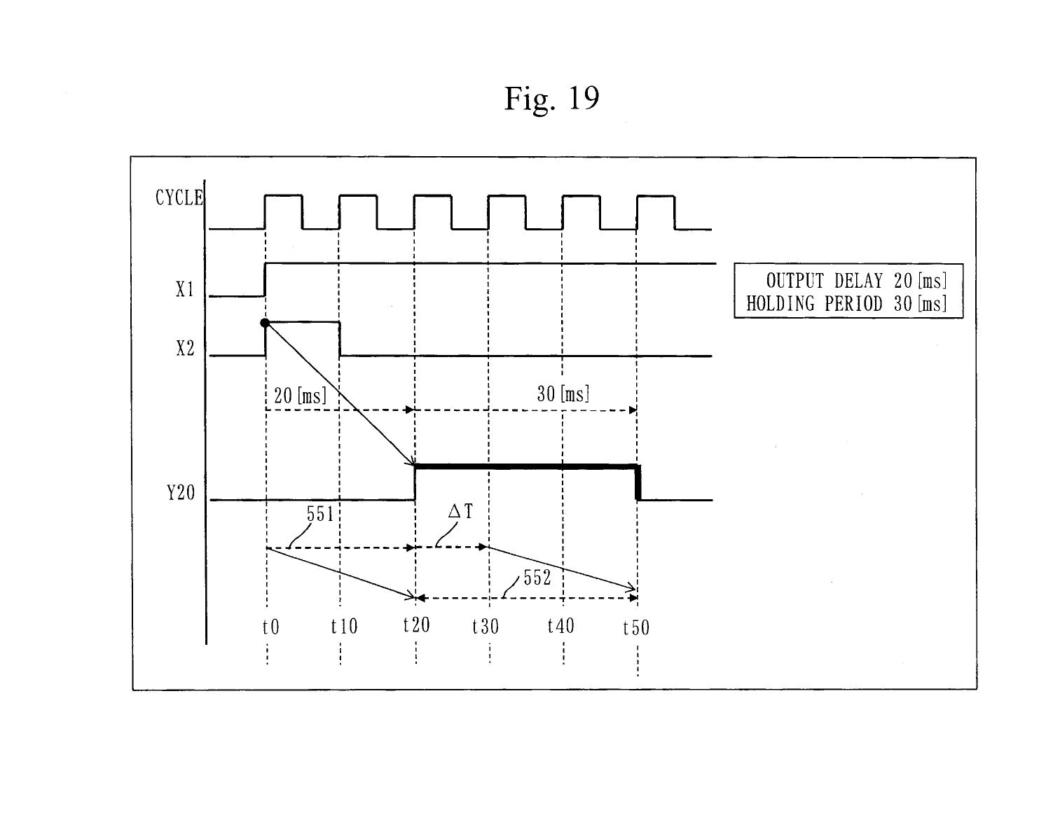

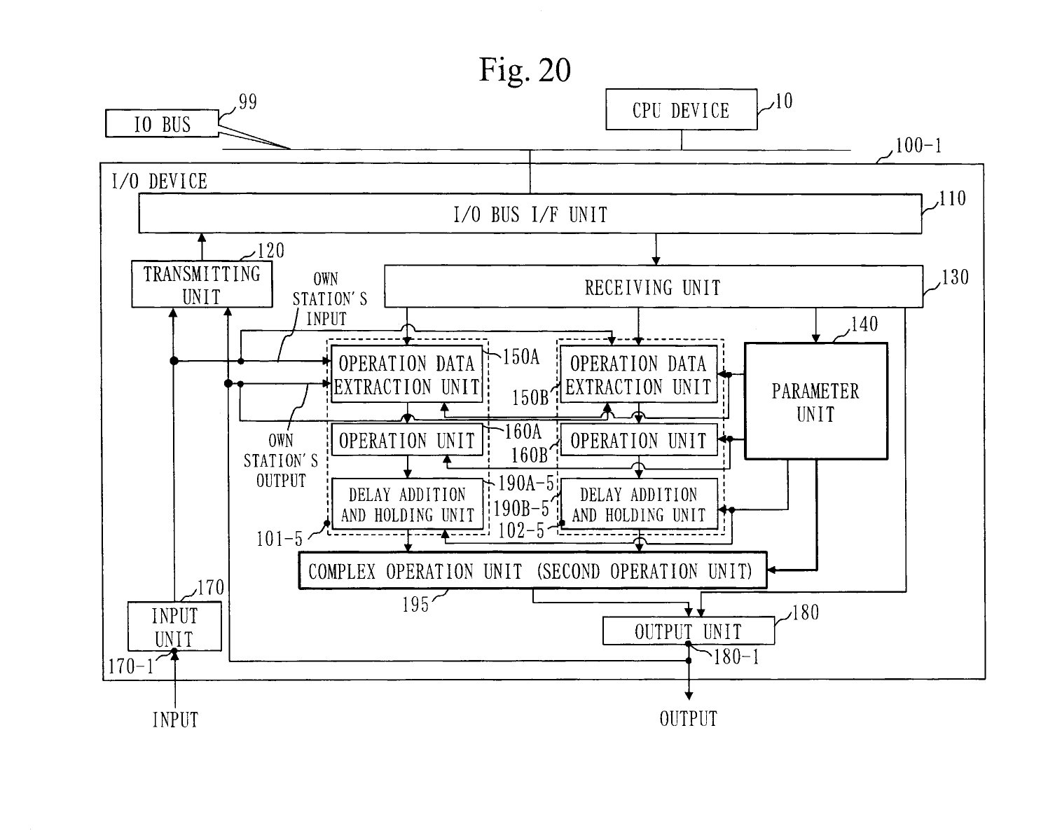

### BRIEF DESCRIPTION OF DRAWINGS

[FIG. 1] is a configuration diagram of a PLC in a first embodiment.

[FIG. 2] is a configuration diagram of an I/O device 100 in the first embodiment.

[FIG. 3] is a block diagram of an operation data extraction unit 150 in the first embodiment.

[FIG. 4] is a block diagram showing a configuration example of an operation unit 160 in the first embodiment.

[FIG. 5] is a table showing parameter setting of an I/O device 100-1 in the first embodiment.

[FIG. 6] is a table showing parameter setting of an I/O device 100-2 in the first embodiment.

[FIG. 7] is a table showing parameter setting of an I/O device 100-3 in the first embodiment.

[FIG. 8] is a block diagram of an operation data extraction unit 150-2 in a second embodiment.

[FIG. 9] is a timing chart showing operations of the operation data extraction unit 150-2 in the second embodiment.

[FIG. 10] is a configuration diagram of the I/O device 100 in a third embodiment.

[FIG. 11] is a block diagram showing a delay addition and holding unit 190 and a parameter unit 140 in the third embodiment.

[FIG. 12] is a diagram showing a series of an AND0 circuit, a delay addition section 1, and a holding section 1 in the third embodiment.

[FIG. 13] is a timing chart showing a delay operation in the third embodiment.

[FIG. 14] is another timing chart showing a holding operation in the third embodiment.

[FIG. 15] is a timing chart showing delay and holding operations in the third embodiment.

[FIG. 16] is a timing chart showing an effect of delay and holding operations in the third embodiment.

[FIG. 17] is a configuration diagram of the I/O device 100 in a fourth embodiment.

[FIG. 18] is a block diagram showing a delay addition and holding unit 190-5 and the parameter unit 140 in a fifth embodiment.

[FIG. 19] is a timing chart showing delay and holding operations in the fifth embodiment.

[FIG. 20] is a configuration diagram of the I/O device 100 in a sixth embodiment.

### DESCRIPTION OF EMBODIMENTS

### First Embodiment.

(Conventional Input Processing)

The term “input processing” and the term “output processing” in the conventional input/output processing described in the background art each have the following meaning: the input processing is processing in which the CPU device 10 collects input terminal information from each I/O device and performs an operation on the input terminal information. The output processing is processing in which the CPU device 10 delivers a result of the operation to the I/O device and the I/O device to which the operation result of its own has been delivered outputs the operation result from the output terminal.

(Input Processing in First and Second Embodiments)

The term “input processing” and the term “output processing” in “input/output processing to be performed among I/O devices at an especially high speed”, which will be described in the following first and second embodiments, each have the following meaning: when attention is focused on the I/O device 100-1 shown in FIG. 1, the input processing is processing in which the I/O device 100-1 collects input terminal information and output terminal information from each of the other I/O device 100-2 and 100-3, and performs an operation using input terminal information and output terminal information of the I/O device 100-1 itself as well. The output processing is processing in which the I/O device 100-1 outputs a result of the operation from the output terminal 180-1 of its own. Each of the I/O devices 100-2 and 100-3 has a configuration equivalent to that of the I/O device 100-1, and performs similar “input/output processing” to that of the I/O device 100-1.

A PLC (programmable logic controller) in the first embodiment will be described. It is assumed that the PLC in the first embodiment has a same configuration as that of FIG. 1. That is, in the PLC in the first embodiment, a connection relationship between each I/O device and the CPU device 10 is assumed to be the same as the connection relationship in FIG. 1. Respective operations of each I/O device and the CPU device 10 are, however, different from those in FIG. 1. FIG. 2 is a configuration diagram of an I/O device 100 in the PLC 1000 in the first embodiment. Referring to FIG. 1, three I/O devices 100 are provided, and these I/O devices 100 are distinguished as the I/O devices 100-1 to 100-3. It is assumed that each I/O device has a same configuration. When the I/O devices do not need to be distinguished, each I/O device is described as the I/O device 100 or the I/O device.

(1) An I/O bus I/F unit 110 is an interface with the I/O bus 99. The I/O bus I/F unit 110 performs control over transmission and reception of data with the CPU device 10 and transmission and reception of data among the I/O devices. Hereinafter, the I/O bus I/F unit 110 will be abbreviated as an I/F unit 110.

(2) A transmitting unit 120 transmits an input signal of the I/O device (received from the input terminal 170-1) and an output signal (output from the output terminal 180-1) to the I/O bus 99 via the I/F unit 110. When a receiving unit 130 receives a read request from the CPU device 10 via the I/F unit 110, the transmitting unit 120 transmits to the CPU device 10 data in response to the request. Each I/O device transmits “input and output signals” of its own to all of the other I/O devices at an equal, regular, or transmittable timing.

(3) The receiving unit 130 receives data from the I/O bus 99 via the I/F unit 110. The receiving unit 130 receives the data from the CPU device 10 when a request for writing (CPU update data in FIG. 2) into the output signal of the I/O device is made or when parameter setting (which will be described later) is performed in the I/O device. The receiving unit 130 also receives input and output signals transmitted from each I/O device.

(4) A parameter 140 unit stores parameters. The parameters are selecting information for extracting only data to be used for an operation by an operation unit 160 from the “input and output signals” received from the other I/O devices and “own station's input and output” shown in FIG. 2, which will be described later, in order to perform input/output processing among the I/O devices. The parameter unit 140 also stores parameters each for selecting the type of the operation (setting information for operation processing).

(5) An operation data extraction unit 150 extracts only the data to be used for the operation by the operation unit 160 from the “input/output signals” (received data) received from the other I/O devices or the “own station's input and output”, according to the selecting information (parameters) set in the parameter unit 140, and then holds the extracted data in registers (which will be described later, using FIG. 3). The “input/output signals” received from the other I/O devices or the “own station's input and output” are each bit information formed of a plurality of bits.

(6) The operation unit 160 performs the operation on the data extracted by the operation data extraction unit 150. The operation unit 160 in this embodiment is explained as a configuration formed by implementing a plurality of two-input or one-input logical operation circuits, as an example. FIG. 4 shows a configuration formed by implementing 32 two-input AND circuits, as an example of the operation unit 160.

The operation unit 160 may be constituted from an EPROM programmed to output a specific value with respect to a constant input, or a readable and writable non-volatile memory. It is assumed that reading from and writing to the non-volatile memory is performed by the CPU device 10 via the parameter unit 140.

(7) An input unit 170 inputs external data in the form of the input signal.

(8) An output unit 180 outputs to an outside each of data indicating an operation result from the operation unit 160 and write (CPU update data) from the receiving unit 130 obtained by writing by the CPU device 10, in the form of the output signal. The output unit 180 updates an output value to the data from each of the operation unit 160 and the receiving unit 130 when an update request is made from each of the operation unit 160 and the receiving unit 130.

FIG. 3 is a configuration diagram showing insides of the operation data extraction unit 150 and the parameter unit 140 related to the operation data extraction unit 150.

(Operation Data Extraction Unit 150)

(1) “Registers 1 to N” store the data obtained by extracting only the data from the input/output signals received from the other I/O devices and to be used for the operation.

(2) “Write control units 1 to N” perform write control of the extracted data for the registers 1 to N when receiving the “input/output signals” (received data) from the other devices. When the I/O device receives the received data from one of the other I/O devices, a “receiving write signal” is enabled. When a reception station number for identifying the I/O device of a transmission source and a selected station number (extraction source) set in the parameter unit 140 match, each write control unit writes the extracted data into a corresponding one of the registers. When the selected station number set in the parameter unit 140 matches an own station number indicating the I/O device itself, the write control unit writes the extracted data into a corresponding one of the registers irrespective of the value of the receiving write signal.

(3) First selection units 151(1) to 151(N) respectively select the data according to the parameters of selected types 1 to N. Second selection units 152(1) to 152(N) respectively select the data according to the parameters of data positions 1 to N. Each of the first selection units and the second selection units is implemented by a multiplexer, for example.

(Parameter Unit 140)

(1) As the “selected types 1 to N”, the parameters are stored, each of which indicates whether the extracted data to be used for operation data is the input signal to its own station (own station's input A) or the output signal from its own station (own station's output B), the input signal into one of the other I/O device (different station's input C), or the output signal from one of the other I/O device (different station's output D).

(2) As the “data positions 1 to N”, the parameters are stored, each of which indicates the bit position of the data which should be used for the operation data when each of the input signals and the output signals is formed of the plurality of bits.

(3) As “selected station numbers 1 to N”, the parameters are stored, each of which indicates the station number of the input signal or the output signal of the I/O device which should be used for the operation data.

(4) As the “own station number”, a parameter indicating the station number of the I/O device itself is stored.

(5) As “operation processing 141”, operation processing shown in FIGS. 5 to 7 (such as an operation output 0, an operation output 1, and so forth) are set.

(Sub-Extraction Units)

Referring to FIG. 3, the first selection unit 151 (1), the second selection unit 152(1), and the register 1 constitute a sub-extraction unit (1). The first selection unit 151(2), the second selection unit 152(2), and the register 2 constitute a sub-extraction unit (2). Similarly, the first selection unit 151(N), the second selection unit 152(N), and the register N constitute a sub-extraction unit (N). In this manner, the operation data extraction unit 150 includes a plurality of sub-extraction units each of which extracts the operation data. As shown in FIG. 3, the parameter unit 140 stores, for each sub-extraction unit, an extraction condition associated with the sub-extraction unit. Each sub-extraction unit extracts the operation data for input according to the parameters associated with the sub-extraction unit.

(Configuration of the Operation Unit 160)

FIG. 4 is a block diagram showing a configuration example of the operation unit 160. Reference sign R(1) and so forth in FIG. 4 indicate the registers. The operation unit 160 in FIG. 4 is configured by implementing 32 (N=32) two-input AND circuits. It is assumed that each I/O device has a maximum of 32 input signal lines (of the input terminal 170-1) and a maximum of 32 output signal lines (of the output terminal 180-1). Corresponding to the maximum numbers of the input and output signal lines, the 32 two-input and one-output AND circuits are implemented in the operation unit 160 in FIG. 4. A total of 32 outputs of AND circuits 0 to 31 are associated with the 32 output signal lines. As shown in FIG. 4, the number of the registers in the operation data extraction unit 150 is 64. This is because one of two inputs of each AND circuit is associated with one of the registers.

That is, a number N of the registers is:

“the number of the AND circuits×the number of inputs to the AND circuits=32×2=64”.

Naturally, 64(N=64) first selection units 151 (N), 64(N=64) second selection units 152 (N), and 64 (N=64) write control units N are also provided, corresponding to the 64 (N=64) registers. This is an example for explaining the configuration of the operation unit 160. The operation unit 160 may be formed of both of AND circuits and OR circuits, or any logic circuit may be used for the operation unit 160. In the example in FIG. 4, the value of one register is associated with one AND circuit alone. However, the value of one register may be used for a plurality of logic circuits.

Next, operation of the I/O device will be described. In usual “input/output processing”, the CPU device 10 collects input terminal information of each I/O device and performs operation processing (input processing), and then delivers an operation result of the operation processing to the I/O device of an output destination (output processing), as in the processing described in the background art. The I/O device to which the operation result has been delivered outputs the operation result to the output terminal 180-1.

(Parameter Setting)

When input/output processing is performed among the I/O devices at an especially high speed, the CPU device 10 sets the parameters for performing the input/output processing among the I/O devices in the parameter unit 140 of each I/O device 100 in advance before the input/output processing is performed. As the parameters, the CPU device 10 sets the selecting information of the operation data to be used for the input/output processing among the I/O devices and sets in the operation processing 141 of the parameter unit 140 the operation processing (operation output 0, operation output 1, and so forth in FIG. 5) to be used for the input/output processing among the I/O devices. FIGS. 5 to 7 which will be described later each show two kinds of the operation output 0 and the operation output 1. However, when the 32 AND circuits are used as in FIG. 4, an operation output is set in each AND circuit. It means that 32 operation outputs of the operation outputs 0 to 31 are set in the operation processing 141 of the parameter unit 140.

The 32 operation outputs of the operation outputs 0 to 31 are associated with the 32 output signal lines.

FIGS. 5 to 7 each show an example of the parameters set in each of the I/O devices 100-1 to 100-3. As described in the explanation of FIG. 4, it is assumed that each I/O device has the maximum of 32 input signal lines (of the input terminal 170-1) and the maximum of 32 output signal lines (of the output terminal 180-1).

After the parameter setting, the PLC 1000 transitions to usual input/output processing by the PLC.

(1) In the “usual input/output processing” by the CPU device 10, the CPU device 10 collects information of an input signal of each I/O device via the I/F unit 110 of the I/O device.

(2) The CPU device 10 performs operation processing using the collected data (input signals), and then outputs an operation result of the operation processing to the I/O device of an output destination via the I/F unit 110 and the receiving unit 130 of that I/O device. When the receiving unit 130 of the I/O device receives an update of the output by the CPU device 10, or when the receiving unit 130 receives the operation result from the CPU device 10, the output unit 180 outputs to the output terminal 180-1 data (operation result) received from the CPU device 10.

In the input/output processing to be performed among the I/O devices at high speed, each I/O device acquires the bus right of the I/O bus 99 and then transmits data of “input and output signals” of its own station to all of the other I/O devices at an equal, regular, or transmittable timing. It is assumed that, when contention occurs with an access to the I/O bus by the CPU device 10, the bus right is preferentially given to the CPU device 10.

(I/O device 100-1)

The I/O device 100-1 sequentially receives from the I/O device 100-2 and the I/O device 100-3 input and output signals of each of the I/O device 100-2 and the I/O device 100-3. When attention is focused on the I/O device 100-2, for example, the input signal (input information) refers to an instance when the I/O device 100-1 receives an own station's input of the I/O device 100-2 corresponding to the own station's input (in FIG. 2) of the I/O device 100-1, through the I/O bus 99. Similarly, when attention is focused on the I/O device 100-2, the output signal (output information) refers to an instance when the I/O device 100-1 receives an own station's output of the I/O device 100-2 corresponding to the own station's output (in FIG. 2) of the I/O device 100-1, through the I/O bus 99. The same also holds true for the I/O device 100-3. When the I/O device 100-1 receives the input signal from the I/O device 100-2, the “input signal” from the I/O device 100-2 is input to the “different station's input C” of the “received data” in FIG. 3. In this case, “2” is input to the “reception station number”, and the receiving write signal is enabled.

(Operation Input Data 1)

As shown in FIG. 5, the parameters (for the selected type, the selected station number, and the data position) for operation input data 1 (operation data) which will be output from the register 1 are set as follows:

Selected Type=different station's input

### Selected Station Number=2

### Data Position=3.

For this reason, the first selection unit 151(1) selects the “input signal” from the I/O device 100-2, and the second selection unit 152(1) selects bit 3 of the input signal. Since the reception station number =the selected station number =2, the receiving write signal is enabled. For this reason, the write control unit 1 writes extracted data in bit 3 into the register 1. Accordingly, the operation input data 1 takes the value of bit 3 of the input signal from the I/O device 100-2.

Similarly, the parameters for each of operation input data 3 and operation input data 4 are also set to be the selected type=different station's input and the selected station number=2 in FIG. 5. Thus, the operation input data 3 and the operation input data 4 respectively assume the value of bit 5 of the input signal from the I/O device 100-2 and the value of bit 6 of the input signal from the I/O device 100-2. By updating of the operation input data, the operation unit 160 outputs an operation result according to the “operation processing 141” in which the parameters have been set.

As shown in FIG. 5, the operation output 0 of the I/O device 100-1 becomes a result of an operation according to “the operation input data 1 AND the operation input data 2”.

The operation output 1 becomes a result of an operation according to “the operation input data 3 OR the operation input data 4”. Though the operation output 1 in the configuration diagram of FIG. 4 is a result of an operation according to “the operation input data 3 AND the operation input data 4”,FIG. 5 shows a case where the “OR” operation has been used.

When receiving the update of the output of the operation result from the operation unit 160, the output unit 180 of the I/O device 100-1 outputs this updated operation result.

Conventionally, even if input signals each formed of a plurality of hits have been received, input/output processing among I/O devices cannot be processed in parallel, so that it takes time. As described above, however, input/output processing of a plurality of data (data output from the registers 1 to N) among the I/O devices may be processed in parallel. That is, as illustrated in FIG. 4, parallel processing of the plurality of data (output from the registers 1 to N) using the 32 AND circuits becomes possible. Accordingly, there is an effect of speeding up the processing.

Further, there is no need for providing in each I/O device the memory (described in Patent Literature 1) for storing data not to be used for an operation or the MPU (described in Patent Literature 2). Consequently, the input/output processing among the I/O devices may be implemented at low cost.

(I/O device 100-2)

Next, the I/O device 100-2 sequentially receives from the I/O device 100-1 and the I/O device 100-3 “input and output signals” of each of the I/O device 100-1 and the I/O device 100-3. When the I/O device 100-2 receives the output signal from the I/O device 100-3, this output signal is input to the different station's output (in FIG. 3). Further, “3” is input to the reception station number, and the receiving write signal is enabled. The parameters (for the selected type, the selected station number, and the data position) for operation input data 3 are set, as shown in FIG. 6. For this reason, the first selection unit 151(3) for the operation input data 3 selects the output signal from the I/O device 100-3 which is the different station's output, according to the “selected type”. Since the “data position” is 0, the second selection unit 152(3) selects bit 0 of the output signal. Since the “reception station number” is “3” and the selected station number is 3, the “reception station number” and the selected station number match with each other. The receiving write signal is also enabled. For this reason, the write control unit 3 writes extracted data in bit 0 into the register 3. Accordingly, the operation input data 3 takes the value of bit 0 of the output signal from the I/O device 100-3. The operation output 1 of the I/O device 100-2 takes the value of the operation input data 3, based on FIG. 6. The operation unit 160 outputs the operation result.

As described above, input/output processing of an output signal from a different one of the I/O devices as well as an input signal to a different one of the I/O devices among the I/O devices may also be processed in parallel.

(I/O device 100-3)

Next, the I/O device 100-3 receives from the I/O device 100-2 an “input signal” and receives from its own station (I/O device 100-3 itself) “input and output signals”. The input signal which the I/O device 100-3 has received from its own station is input to the “own station's input A” (in FIG. 3). The output signal is input to the “own station's output B”.

(Operation Input Data 1)

As shown in FIG. 7, the parameters for operation input data 1 are set as follows:

Selected Type=own station's input

### Selected Station Number=3

### Data Position=1.

For this reason, the first selection unit 151(1) selects the input signal from the I/O device 100-3, which is the own station's input, and the second selection unit 152(1) selects bit 1 of the input signal. Since the own station number is 3 and the selected station number is also 3, the own station number and the selected station number match with each other. Thus, the write control unit 1 writes extracted data in bit 1 into the register 1. Accordingly, the operation input data 1 takes the value of bit 1 of the input signal from the I/O device 100-3.

(Operation Input Data 2)

Similarly, bit 1 of the output signal from the I/O device 100-3 is extracted as operation input data 2. Since the own station number is 3 and the selected station number is also 3, the own station number and the selected station number match with each other. Thus, the write control unit 2 writes extracted data in bit 1 into the register 2. As the operation output 0 of the I/O device 100-3, a result of an operation according to “the operation input data 1 OR the operation input data 2” is output.

(Operation Input Data 3 and 4)

When an “input signal” (different station's input) is received from the I/O device 100-2, operation input data 3 takes the value of bit 4 of the input signal input as the “different station's input”. An input signal received from the own station of the I/O device 100-3 is input to the “own station's input A”, and operation input data 4 takes the value of bit 0 of the input signal.

As the operation output 1 of the I/O device 100-3, a result of an operation according to “the operation input data 3 AND the operation input data 4” is output.

As described above, input/output processing of input and output signals of the I/O device input into and output from its own station may be also processed in parallel, as in the case of an input signal from one of the other I/O devices. Further, bit 0 of an input signal of the I/O device 100-3 is set to operation input data for all of the I/O devices 100-1 to 100-3. By specifying a bit such as bit 0 of the input signal of the I/O device 100-3 as the operation input data and causing each I/O device to perform input/output processing of the bit, an operation such as stopping or starting of each I/O device may be controlled at high speed.

### Second Embodiment

The second embodiment will be described, with reference to FIGS. 8 and 9. In the above-mentioned first embodiment, the operation data extraction unit 150 immediately transmits data of input and output signals from the I/O device of its own station and the other I/O devices to the operation unit 160. However, in operation processing in which the data from the different I/O devices are input, a timing of receiving the data is different according to each I/O device. Thus, updating of each operation input data is not synchronized. In the case of input/output processing to be asynchronously controlled among the I/O devices, there is no problem with the operation method in the first embodiment. In the case of input/output processing to be synchronously controlled among the I/O devices, however, an unexpected operation result is output. Then, an embodiment will be shown in which input data are synchronized among the I/O devices.

FIG. 8 is a configuration diagram showing insides of an operation data extraction unit 150-2 which applies synchronization control over extracted data and the parameter unit 140 related to the operation data extraction unit 150-2. FIG. 8 is different from FIG. 3 in the configuration of the operation data extraction unit 150-2. The operation data extraction unit 150-2 is obtained by adding a synchronization signal S, a transmission signal T, and registers 1a to Na to the operation data extraction unit 150 in FIG. 3. The registers 1a to Na respectively store data stored in the registers 1 to N when the synchronization signal S from the I/F unit 110 is enabled. Upon receipt of input signals and output signals (received data) from the other /O devices, the write control units 1 to N respectively perform write control of the extracted data for the registers 1 to N. When data is received from one of the other I/O devices, a receiving write signal is enabled. Then, when a reception station number for identifying the I/O device of a transmission source and a selected station number set in the parameter unit 140 match with each other, the extracted data is written into the register. When the selected station number set in the parameter unit 140 matches the own station number indicating the I/O device itself, the extracted data is written into the register when the transmission signal T from the I/F unit 110 is enabled.

When the I/F unit 110 in the second embodiment transmits data of “input and output signals” to the other I/O devices in the configuration diagram of the I/O device in FIG. 2, the I/F unit 110 enables the transmission signal T. Further, when the I/F unit 110 transmits the data of “input and output signals” to the other I/O devices from its own station and data reception from all the I/O devices is finished, the I/F unit 110 enables the synchronization signal S. Each I/O device equally acquires the bus right of the I/O bus 99 and transmits the data to all of the other I/O devices. For this reason, the I/F unit 110 may confirm data transfer from all the I/O devices within a certain period of time.

Next, operation will be explained. FIG. 9 shows a timing chart in which each I/O device transmits data of an input signal and an output signal to the other I/O devices, and the I/O devices receive the data. FIG. 9 also shows a timing chart with respect to the synchronization signal S and updating of operation input data.

As shown in FIG. 9, data of each I/O device is sequentially transmitted and received in the order from the I/O device 100-1, the I/O device 100-2, to the I/O device 100-3. When the I/O device 100-1 transmits data 1b, the transmission signal T is enabled and the register with the selected station number thereof set to the I/O device 100-1 is updated to the transmitted data, in the I/O device 100-1. When each of the I/O device 100-2 and the I/O device 100-3 receives the data 1b, the receiving write signal is enabled, and the register with the selected station number thereof set to the I/O device 100-1 is updated to the received data. Similarly, when the I/O device 100-2 and the I/O device 100-3 respectively transmit data 2b and data 3b, the transmission signal T is enabled at each of the I/O devices which have respectively transmitted the data 2b and 3b, and the register with the selected station number thereof set to its own station number in each of the I/O devices that have respectively transmitted the data 2b and 3b is updated to the transmitted data. At each I/O device which has received the data, the receiving write signal is enabled, and the register for which the selected station number matches the reception station number is updated to the received data.

When transmission and reception of the data with respect to the I/O device 100-3 is completed, data transfer from all the I/O devices is completed. For this reason, the synchronization signal S is enabled at the timing of completion of the data transfer. That is, the I/F unit 110 of each I/O device enables the synchronization signal S, at that timing. By the synchronization signal S being enabled, the operation input data is updated from operation input data 1a to Na to new operation input data 1b to Nb.

As described above, input data may be synchronized among the I/O devices by the synchronization signal S. Thus, input/output processing may be synchronously performed among the I/O devices. Further, since input/output processing of a plurality of data may be performed in parallel, the processing may be performed at high speed.

In the above-mentioned embodiment, in the programmable logic controller including the CPU device and the I/O devices, each of the I/O device includes means for communication among the I/O devices, storage means for storing the parameters which are setting information on data and operations to be used for input/output processing, extraction means for extracting only the data necessary for the input/output processing, and operation means for performing an operation of the input/output processing. Each I/O device may process the input/output processing of a plurality of data in which only the data necessary for the input/output processing has been extracted from received data, in parallel.

In the above-mentioned embodiment, the following I/O device was explained. The I/O device includes control means for synchronously inputting data received among the I/O devices and then performing input/output processing of the input data. The I/O device may perform the input/output processing of a plurality of data in which only the data necessary for the input/output processing has been extracted from received data, in parallel and in synchronization.

### Third Embodiment

FIG. 10 shows a configuration diagram of the I/O device 100 in a third embodiment. The I/O device 100 in FIG. 10 further includes a delay addition and holding unit 190 in a stage subsequent to the operation unit 160 (shown in FIGS. 2 to 4) in the first embodiment, or in a stage subsequent to the operation unit 160 in the second embodiment (in FIG. 8).

(Delay Addition and Holding Unit 190)

FIG. 11 is a diagram showing a relationship among the delay addition and holding unit 190, the parameter unit 140, and the operation unit 160 in the I/O device 100 in FIG. 10. FIG. 11 is based on FIG. 4. A shown in FIG. 11, the delay addition and holding unit 190 (output period determination unit) inputs results of operations (M1), (M2) . . . , and (M32) obtained by execution in parallel by the operation unit 160. The delay addition and holding unit 190 determines each of output timings (also referred to as a delay period or a delay time which will be described later) of the input operation results (M1), (M2), . . . and (M32) and an output continuation time (also referred to as a holding period or a holding time which will be described later), and outputs each of the input operation results (M1), (M2), . . . and (M32) according to the determination.

(Parameter Unit 140)

The parameter unit 140 stores in advance the delay time and the holding time determined by the delay addition and holding unit 190 as parameters (output period information). As shown in FIG. 11, the parameter unit 140 stores delay values 1 to 32 as the delay times for the respective operation results (M1) and so forth. The parameter unit 140 stores holding periods 1 to 32 as the holding times (holding periods) for the respective operation results (M1) and so forth. To take an example, the delay addition and holding unit 190 processes the operation result (M1) of an “AND0” circuit, as follows:

(1) when inputting the operation result (M1), a delay addition section 1 outputs the operation result (M1) after a lapse of the delay time indicated by the delay value 1 from a time point at which the delay addition section 1 has input the operation result (M1), according to the delay value 1 stored in the parameter unit 140. The delay value 1 may be zero (with no delay).

(2) when inputting the operation result (M1) that is the output of the delay addition section 1, a holding section 1 continues output of the operation result (M1) during a time indicated by a holding period 1, according to the holding period 1 stored in the parameter unit 140.

(3) The same also holds true for the operation data (M2) to (M32) that have been input from the operation unit 160 by the delay addition and holding unit 190. That is, delay and output continuation are executed for the operation data (Mi) (i=2, 3, 4 . . . , 32) by a delay addition section (i) and a holding section (i).

In the third embodiment, the following conditions 1 to 3 are provided for delaying by the delay addition section and holding by the holding section, as an example. By providing these conditions, the I/O device 100 having the effect of the third embodiment and in which the need for holding a large quantity of output signals (operation results) is eliminated may be implemented with a small circuit size.

<Condition 1: Condition with Respect to Delaying by Delay Addition Section>

During a delay period (delay period 301 which will be described later) of an operation result, a change in the operation result is not reflected in an output.

<Condition 2: Condition with Respect to Holding by Holding Section>

When an operation result changes during a holding period (holding period 302 that will be described later), the holding section starts to output the changed operation result immediately after the change of the operation result without delaying the changed operation result, and continuously outputs the changed operation result during the holding period.

<Condition 3: Condition with Respect to Delaying and Holding>

When setting a delay according to the method in the third embodiment, a limitation is given by the following expression (1):

Delay Period (Delay of Output)≦Holding Period (1)

A specific example of delaying by the delay addition section and holding by the holding section will be described, using FIGS. 13 to 15. Referring to FIGS. 13 to 15, the following settings 11 to 13 are set for the delay addition section, and the following settings 21 to 22 are set for the holding section.

<Delay Addition Section>

(Setting 11) The delay addition section starts delay processing by being triggered by a change in an input to the delay addition section itself.

(Setting 12) The delay addition section receives no input during the delay period (according to the above-mentioned condition 1).

(Setting 13) When an input value at a start of the delay period has no change in the value after a lapse of the delay period, the delay addition section continues output of the unchanged input value until an input change occurs. When there is the input change at the elapse of the delay period, the delay addition section starts the delay processing by being triggered by the input change, as in the setting 11.

<Holding Section>

(Setting 21) The holding section starts holding processing immediately after a change in an input to the holding section itself (according to the above-mentioned condition 2).

(Setting 22) The holding section receives no input during the holding period.

(Setting 23) When an input value at a start of the holding period has no change in the value after a lapse of the holding period, the holding section continues output of the unchanged input value until an input change occurs. When there is the input change, the delay addition section starts the holding processing by being triggered by the input change, as in the setting 21.

FIG. 12 is a diagram showing a series of the AND0 circuit, the delay addition section 1, and the holding section 1 shown in FIG. 11. Though FIG. 12 and the following explanation explain about the series of the AND0 circuit, the explanation about the AND0 circuit also applies to a series of each of the other AND2 to AND31 circuits.

FIG. 13 is a timing chart when delay setting of 20 ms (output delay of 20 ms) and holding setting of 0 ms are made for an AND operation in FIG. 12. The “holding period=0 ms” means that there is not the holding section 1 in FIG. 12, and an output (Y10) is output without alteration, as an output (Y20). As shown in FIG. 13, an AND operation result X3=1 is output as the output Y10=1 after having been delayed by 20 ms. Even if the AND operation result (X3) becomes 0 after 10 ms in this case, the output Y10 of 1 is output without alteration during the period of 20 ms.

FIG. 13 will be explained in further detail.

(1) Time (t0)

At a time (t0), the operation result (X3) which is an input to the delay addition section 1 changes from 0 to 1. Accordingly, the delay addition section 1 starts counting down of the output delay of 20 ms, and does not output the “operation result X3=1” until counting down of 20 ms, which is the delay period 301, is finished. Further, the delay addition section 1 receives no input during a period from the time (t0) to a time (t20), which is the delay period 301 until the counting down is finished.

(2) Time (t20) (Start of Outputting of the Output Y10=1)

At the time (t20) when the counting down is finished, the delay addition section 1 starts outputting the “output Y10=1”, using the “operation result X3=1” as the “output Y10=1”. In this case, the delay addition section 1 receives no input during the delay period 301 from the time (t0) to the time (t20).

(3) Time (t20) (Reception of Input of the Operation Result X=0)

At the time (t20), the counting down is finished. Before this point, the operation result (X3) has become 0 from 1 at the preceding time (time (t0)). Accordingly, there is an input change at the point of time when the counting down is finished. Thus, the delay addition section 1 starts counting down, and does not output the “operation result X3=0” until the counting down is finished.

(4) Time (t40) (Start of Output of the Output Y10=0)

At a time (t40) when the counting down is finished, the delay addition section 1 starts outputting the “output Y10=0”, using the operation result “X3=0” as the “output Y10=0”. In this case, the delay addition section 1 receives no input during the delay period 301 from the time (t20) to the time (t40).

(5) Time (t40) (Input Process of the Operation Result X3)

At the time (t40), the counting down is finished. At this point, the input (X3)=0, which is the same as the value at the preceding time (time (t20)). Accordingly, there is no input change at the point of time when the counting down is finished. Thus, until a subsequent change in the input signal (X3) occurs, the delay addition section 1 continues outputting the output Y10=0 without starting the delay processing caused by a change in the signal.

FIG. 14 shows a timing chart when delay setting of 0 ms and holding setting of 20 ms (holding period 302=20 ms) are made for the AND operation. The delay setting of 0 ms means that the delay addition section 1 is not present in FIG. 12, and the AND operation result X3 is output without alteration, as the output Y10. The holding section 1 continues output of the input (Y10) just during the holding period 1 (in FIG. 11) stored in the parameter unit 140. The holding period 1 (in FIG. 11) corresponds to the holding period 302 in FIG. 14. Since the delay setting of 0 ms is made, the operation result X3 is the same as the input Y10, in FIG. 14.

(1) Time (t0)

At a time (t0), the operation result (Y10), which is an input to the holding section 1, changes from 0 to 1. Accordingly, the holding section 1 continues outputting “1” during the holing period 302 of 20 ms. The holding period 1 receives no input during the holding period 302. Thus, even if the input (Y10) has become 0 at a time (t10), the holding section 1 does not receives this input, so that the holding section 1 outputs 1 without alteration during the holding period 302 of 20 ms (from the time t0 to a time t20). The holding section 1 continues to output the operation result (input (Y10)) during the holding period 302, in this manner. Then, after a lapse of the holding period 302, the holding section 1 receives the operation result of 0 and then outputs the value of 0 of the operation result.

(2) Time (t20)

At the time (t20) when the holding period 302 has elapsed, the holding section 1 receives the input (Y10). Before the time (t20), the input (Y10) has changed from 1 to 0. Accordingly, the holding section 1 continues outputting “0” during the holding period 302 of 20 ms (from the t20 to a time t40).

(3) Time (t40)

At the time (t40) when the holding period 302 has elapsed, the holding section 1 receives the input (Y10). At the time (t40), the input (Y10) remains unchanged at 0 from the time (t20). Accordingly, the holding section 1 continues output of the current input Y10=0 during a period 402 after the time (t40) until the input (Y10) changes.

FIG. 15 shows a timing chart when an output delay of 20 ms and a holding period of 30 ms are set for the AND operation based on FIG. 12. Since the output delay is set to 20 ms, waveforms of outputs X1, X2, X3 and Y10 are the same as those in FIG. 13. Only an output Y2 has a different waveform. It is assumed that in the delay setting, the following expression (1) is to be satisfied according to the above-mentioned condition (3):

Delay Period 301 (Output Delay)≦Holding Period 302 (1)

When the condition of the expression (1) is not satisfied, an operation that is the same as in the case of the holding period of 0 ms is performed. Referring to FIG. 15, the output delay (delay value) is set to 20 ms and the holding period is set to 30 ms. Thus, the above-mentioned expression (1) is satisfied. The output Y20 in FIG. 15 will be briefly explained. Since the outputs X1, X2, X3, and Y10 are the same as those in FIG. 13, explanation of the outputs X1, X2, X3, and Y10 will be saved.

(1) Time (t0)

At a time (t20), the operation result (Y10), which is an input to the holding section 1 changes from 0 to 1. Accordingly, the holding section 1 continues outputting “1” during the holding period 302 of 30 ms (from the time t20 to a time t50). The holding section 1 receives no input during the holding period 302. Accordingly, the holding section 1 does not receive the input (Y10) even if the input (Y10) has become 0 at the time (t40). The holding section 1 outputs “1” without alteration during the holding period 302 of 30 ms (from the time 20 to the time 50).

(2) Time (t50)

At the time (t50) when the holding period 302 has elapsed, the holding section 1 receives the input (Y10). Before the time (50), the input (Y10) has changed from 1 to 0. Accordingly, the holding section 1 continues outputting “0” during the holding period 302 of 30 ms (from the time t50 to a time 80).

(3) Time (t80)

At the time (t80) when the holding period 302 has elapsed, the holding section 1 receives the input (Y10). At the time (80), the input (Y10) remains unchanged at 0 from the time (t50). Accordingly, the holding section 1 continues to output the current output Y10=0 until a change in the input (Y10) occurs during a period 402 after the time (t80).

In the third embodiment, the I/O device 100 performs delay addition and holding of the value of each of results of operations on “own station's input and output” and “different station's input and output”, and provides a resulting output. The delay time and the holding time in that case are respectively determined by the parameters (delay value and holding period) stored in the parameter unit 140. In the case of the I/O device that uses an output of the I/O device as input data of the I/O device, the I/O device does not communicate with the other I/O devices, performs an operation within the I/O device itself, performs delay addition and holding of a result of the operation, and then outputs the result of the operation. In the case of the I/O device that uses an output of a different one of the I/O devices as input data of the I/O device, communication is performed between the I/O device and the different one of the I/O devices. Then, the I/O device that is to provide an output of a result of an operation, performs the operation, performs delay addition and holding of the result of the operation, and then outputs the result of the operation.

FIG. 16 is a diagram explaining an effect of delay addition by the delay addition section and holding by the holding section. FIG. 16 describes “delay addition and holding” as “delay addition”. Three graphs 501 to 503 on an upper side of FIG. 16 show a case where the “delay addition and holding” in the third embodiment is not performed. Three graphs 602 to 604 on a lower side of FIG. 16 show a case where the “delay addition and holding” in the third embodiment is performed. The graph 501 shows an input to the I/O device 100. The graph 502 shows an output of the I/O device with “no delay”. Referring to the graph 502, the output is delayed from the input in the graph 501 by 1 ms. This delay is a time needed for communication between the devices. A cycle of communication between the devices is 1 ms, as shown in FIG. 16. The graph 503 shows an output with “delay addition” caused by using the CPU device 10 as an intermediary. In the case of the “delay addition” through the intermediary of the CPU device 10, the output cannot be provided earlier than a cycle of communication with the CPU device 10 of 5 ms. Thus, an output timing of an operation result of the I/O device 100 is the granularity of the cycle of communication with the CPU device 10 of 5 ms. That is, when the “delay addition” through the intermediary of the CPU device 10 is performed, an output 702 with the “delay addition” is provided after the cycle of communication with the CPU device 10 of 5 ms, on contrast with an output 701 with “no delay”.

On the other hand, the graphs 602 to 604 indicating the third embodiment are as follows. Since the graph 602 shows the same content as the graph 502, explanation of the graph 602 is omitted. The graph 603 shows an output when a first delay setting amount 801 is set. The graph 604 shows an output when a second delay setting amount 802 is set. As shown in the graph 603, the I/O device 100 may provide the output earlier than the cycle of communication with the CPU device 10 of 5 ms. That is, the output timing of an output 803 is not limited by the granularity of the communication cycle. Further, as shown in the graph 604, by setting the delay setting amount 802 different from the delay setting amount 801, continuous operations may be sequentially performed in a short period of time. That is, as shown in FIG. 16, an interval between the output 803 with the delay setting amount 801 and an output 804 with the delay setting amount 801 may be freely set.

As described above, the I/O device 100 in the third embodiment may perform delay addition and delaying by the delay addition and holding unit 190 without performing communication with the CPU device 10. Consequently, the following effects are obtained:

(1) Delay addition in a short period of time and operation value holding in a short period of time may be implemented.

(2) Since the I/O device 100 that is to provide an output performs delay addition and holding, the timing of providing the output is not limited by the granularity of the communication cycle.

(3) Since values of setting value registers for delay addition and holding are set in the parameter unit 140 by the CPU device 10 as the parameters, these parameters may be changed through the I/O bus 99. Assume that an emergency error signal of one of a plurality of devices has been input to the I/O device 100 through the input terminal 170-1, for example. Then, with the above-mentioned arrangement, a request for changing a plurality of output signals (operation results X3 to be output as outputs Y10 in FIG. 12) of the I/O devices in a predetermined order and performing stop processing according to the emergency stop order of the plurality of devices in a shortest possible period of time may be accommodated.

A shown in FIG. 11, the delay addition and holding unit 190 in the third embodiment includes a delay addition section for delaying and a holding section for holding, for each output signal (operation result) of the I/O device 100. Each of delay addition sections and holding sections includes a counter. The counter of each delay addition section counts down a delay period. The counter of each holding section counts down a holding period. Each of the delay addition sections 1 to 32 performs delaying until counting down of a corresponding one of the delay values 1 to 32 stored in the parameter unit 140 is completed. Each of the holding sections 1 to 32 performs holding until counting down of a corresponding one of the holding periods 1 to 32 stored in the parameter unit 140 is completed. With this arrangement, a memory for a database or the like is not necessary, so that the configuration of the I/O device is simplified.

### Fourth Embodiment

FIG. 17 is a configuration diagram of the I/O device 100 in a fourth embodiment. The I/O device 100 in the fourth embodiment has a configuration in which a complex operation unit 195 (second operation unit) is added in a stage subsequent to the delay addition and holding unit 190 in the I/O device 100 in the third embodiment. As shown in FIG. 17, the I/O device 100 in the fourth embodiment includes a first series 101 formed of an operation data extraction unit 150A, an operation unit 160A, and a delay addition and holding unit 190A and a second series 102 formed of an operation data extraction unit 150B, an operation unit 160B, and a delay addition and holding unit 190B. The receiving unit 130 outputs different station's input and output to the operation data extraction units 150A and 150B. The input unit 170 outputs an own station's input to the operation data extraction units 150A and 150B. The output unit 180 outputs an own station's output to the operation data extractions 150A and 150B. Each of the delay addition and holding units 190A and 190B outputs an operation result (delayed and held output Y20 shown FIG. 12) to the complex operation unit 195. The complex operation unit 195 executes operation processing using operation results output from the delay adding and holding units 190A and 190B. The parameter unit 140 provides parameters to the operation data extraction units 150A, 150B, and so forth. In this case, the parameter unit 140 stores, as a parameter, operation definition information which defines a method of the operation processing to be executed by using each operation result to be output from each of the delay addition and holding units 190A and 190B. The complex operation unit 195 executes an operation according to the operation definition information of the parameter unit 140.

The complex operation unit 195 may perform a logical operation such as a logical sum (OR) operation or the like. As described above, the operation unit 160 may perform operation processing, and then, the delay addition and holding units 190A and 190B may each perform delay addition and holding. Then, the complex operation unit 195 may perform the operation. For this reason, a complex output is obtained, using a small circuit size.

Though there are two serieses of the first series 101 and the second series 102 in FIG. 17, it may be so configured that only the first series 101 is used. In this case, operation results M(1) to M(32) are output from the delay addition and holding unit 190A, as shown in FIG. 4. Thus, the complex operation unit 195 may perform an operation according to the operation definition information in the parameter unit 140 by using these 32 operation results.

The third embodiment shows a case where 32 serieses formed of the “delay addition section 1 and the holding section 1” to the “delay addition section 32 and the holding section 32” are used, as shown in FIG. 11. This case shows an example. The number of the serieses may be one, or may be 33 or more.

### Fifth Embodiment

A configuration of the I/O device 100 in a fifth embodiment will be explained with reference to FIGS. 18 and 19. The I/O device 100 in the fifth embodiment has the configuration in which the delay addition and holding unit 190 (in FIG. 11) in the I/O device 100 in the third embodiment is replaced by a delay addition and holding unit 190-5 shown in FIG. 18. FIG. 18 is associated with FIG. 11. The delay addition and holding unit 190 in the third embodiment is so configured that each of the delay addition sections independently includes the counter and each of the holding sections independently includes the counter, as shown in FIG. 11. On contrast therewith, the delay addition and holding unit 190-5 in the fifth embodiment implements delay addition and holding by one counter, as shown in FIG. 18. To take an example, a subdelay addition and holding section 1-5 in FIG. 18 includes a combined function of the delay addition section 1 and the holding section 1 in FIG. 11. The same also hold true for each of other subdelay addition and holding sections 2-5 to 32-5. When only delaying or only holding is performed, an operation which is the same as that in the third embodiment is performed. When both of delaying and holding are performed, the following operation is performed.

FIG. 19 is a timing chart when delay setting of an output delay of 20 ms and a holding period of 30 ms is made for the AND operation in FIG. 12. This delay setting is the same as that in FIG. 15. An explanation will be made, using the subdelay addition and holding section 1-5 in FIG. 18 as an example. In this case, the delay addition section 1 and the holding section 1 in FIG. 12 constitute the subdelay addition and holding section 1-5. As shown in FIG. 19, the subdelay addition and holding section 1-5 delays “1”, which is a result of the operation by the ANDO circuit (at a time t0) by 20 ms and outputs the delayed operation result (at a time t20). Then, even if the AND operation result becomes “0” after 10 ms (at a time t10), the subdelay addition and holding section 1-5 outputs “1” without alteration during 30 ms (from the time t20 to a time t50). In this manner, the subdelay addition and holding section 1-5 does not receive a change in the operation result during a period (during a delay period 551 from the time t0 to the time t20), where the operation result is delayed, and does not reflect the change in the output. That is, even if a change occurs in an input X2 in the delay period 551 (from the t0 to the time t10), the subdelay addition and holding section 1-5 sets the operation result of “1” at the time t0 to the input X2 in the delay period 551 (from the t0 to the time t10). Further, the subdelay addition and holding section 1-5 does not receive the operation result of the input X2 during a period ΔT=10 ms obtained by subtracting the delay period 551 of 20 ms from a holding period 552 of 30 ms after the delay period 551.

Herein, ΔT=Holding Period 552−Delay Period 551.

That is, as shown in FIG. 19, the delay addition and holding section 1-5 maintains the input of “1” at the time t0 for a period of the “delay period 551 +ΔT” (from the time t0 to the time t30). This input of “1” to be maintained is output (at the time t20) after a lapse of the delay period 551. A period during which this input of “1” is output is equal to the holding period 552 calculated by the following expressions:

“Delay Period 551+ΔT”=Delay Period 551+Holding Period 552−Delay Period 551=Holding Period 552.

At the time t30 (20 ms before the finish of the holding period 552) when the period ΔT (10 ms in this example) obtained by the subtraction has elapsed after the delay period 551, the subdelay addition and holding section 1-5 receives the AND operation result of “0”, delays the AND operation result of “0” by 20 ms (holding period 552−ΔT=delay period 551), and then outputs the AND operation result at the time t50.

The following condition is needed to be satisfied for delay setting:

Delay Period (Output Delay)≦Holding Period

In order to eliminate this condition, it is necessary to temporarily hold a plurality of values to be delayed by output delay setting. Thus, the circuit size will remarkably increase.

### Sixth Embodiment

FIG. 20 is a diagram showing a configuration of the I/O device 100 in a sixth embodiment. FIG. 20 is associated with FIG. 17 showing the configuration of the I/O device 100 in the fourth embodiment. FIG. 20 shows the configuration in which the delay addition and holding unit 190 in FIG. 17 in the fourth embodiment is replaced by the delay addition and holding unit 190-5 in the fifth embodiment. Referring to FIG. 20, each of the delay addition and holding unit 190A-5 and a delay addition and holding unit 190B-5 has the configuration of the delay addition and holding unit 190-5 in FIG. 18.

By setting the I/O device in the sixth embodiment to the configuration in FIG. 20, a complex output may be obtained with a small circuit size as in the case of FIG. 17.

Though there are two serieses of a first series 101-5 and a second series 102-5 in FIG. 20, a configuration including only the first series 101-5 may be used. In this case, operation results M(1) to M(32) are output from the delay addition and holding unit 190A-5 as shown in FIG. 4, which is the same as in the case of FIG. 17.

As in the case of FIG. 17, 32 serieses formed of “subdelay addition and holding section 1-5” to “subdelay addition and holding section 32-5” show an example, in the sixth embodiment as well. The number of the serieses may be one, or may be 33 or more.

### REFERENCE SIGNS LIST

10: CPU device
100-1, 100-2, 100-3: I/O device
110: I/F unit
120: transmitting unit
130: receiving unit
140: parameter unit
141: operation processing
150, 150-2: operation data extraction unit
151: first selection unit
152: second selection unit
160: operation unit
170: input unit
180: output unit
170-1: input terminal
180-1: output terminal
190, 190-5: delay addition and holding unit
195: complex operation unit
1000: PLC
99: I/O bus

1. An I/O (Input/Output) device to be used in a programmable logic controller comprising a CPU (Central Processing Unit) device and a plurality of the I/O devices, the I/O device comprising:
an interface unit which communicates with the CPU device and also communicates with the other I/O devices, the interface unit receiving from each of the other I/O devices input information input to the other I/O device and output information output from the other I/O device;
a parameter unit which stores methods of a plurality of operation processing and a parameter indicating an extraction condition for extracting operation data to be used for the operation processing;
an operation data extraction unit which inputs the input information and the output information of each of the other I/O devices received by the interface unit and also inputs input information input into the own I/O device and output information output from the own I/O device, extracts the operation data from each of the input information and the output information of the other I/O devices which have been input and the input information and the output information of the own I/O device which have been input, according to the parameter stored in the parameter unit, and outputs the extracted operation data; and
an operation unit which executes the plurality of operation processing in parallel, by using the operation data output by the operation data extraction unit and according to the methods of the plurality of operation processing stored in the parameter unit.

2. The I/O device according to claim 1,
wherein the operation data extraction unit includes a plurality of sub-extraction units each of which extracts the operation data;
wherein the parameter unit stores, for each sub-extraction unit, the extraction condition associated with the sub-extraction unit; and
wherein each of the sub-extraction units extracts the operation data according to the parameter associated with the sub-extraction unit.

3. The I/O device according to claim 2,
wherein each of the input information and the output information of the other I/O devices and the input information input into the own I/O device and the output information output from the own I/O device is bit information formed of a plurality of bits;
wherein, as the extraction condition associated with each of the sub-extraction units, the parameter unit stores the extraction condition which specifies one of the input information and the output information of the other I/O devices and the input information input into the own I/O device and the output information output from the own I/O device as an extraction source of the operation data, and specifies a bit position from which a bit value at the specified extraction source is to be extracted; and
wherein each of the sub-extraction units extracts the bit value from the specified bit position of the specified extraction source, as the operation data, according to the extraction condition associated with the sub-extraction unit.

4. The I/O device according to claim 1,
wherein the interface unit outputs a synchronization signal to the operation data extraction unit upon receipt of the input information and the output information from all of the other I/O devices; and
wherein the operation data extraction unit outputs the operation data to the operation unit upon receipt of the synchronization signal.

5. A programmable logic controller comprising a CPU (Central Processing Unit) device and a plurality of I/O (Input/Output) devices, each of the plurality of I/O devices comprising:
an interface unit which communicates with the CPU device and also communicates with the other I/O devices, the interface unit receiving from each of the other I/O devices input information input to the other I/O device and output information output from the other I/O device;
a parameter unit which stores methods of a plurality of operation processing and a parameter indicating an extraction condition for extracting operation data to be used for the operation processing;
an operation data extraction unit which inputs the input information and the output information of each of the other I/O devices received by the interface unit and also inputs input information input into the own I/O device and output information output from the own I/O device, extracts the operation data from each of the input information and the output information of the other I/O devices which have been input and the input information and the output information of the own I/O device which have been input, according to the parameter stored in the parameter unit; and
an operation unit which executes the plurality of operation processing in parallel, by using the operation data extracted by the operation data extraction unit and according to the methods of the plurality of operation processing stored in the parameter unit.

6. An operation method by an I/O device to be used in a programmable logic controller comprising a CPU (Central Processing Unit) device and a plurality of the I/O devices, the operation method comprising:
by an interface unit which communicates with the CPU device and also communicates with the other I/O devices, receiving from each of the other I/O devices input information input to the other I/O device and output information output from the other I/O device;
by a parameter unit, storing methods of a plurality of operation processing and a parameter indicating an extraction condition for extracting operation data to be used for the operation processing;
by an operation data extraction unit, inputting the input information and the output information of each of the other I/O devices received by the interface unit and also inputting input information input into the own I/O device and output information output from the own I/O device, extracting the operation data from each of the input information and the output information of the other I/O devices which have been input and the input information and the output information of the own I/O device which have been input, according to the parameter stored in the parameter unit, and outputting the extracted operation data; and
by an operation unit, executing the plurality of operation processing in parallel, by using the operation data output by the operation data extraction unit and according to the methods of the plurality of operation processing stored in the parameter unit.

7. The I/O device according to claim 1,
wherein the parameter unit further stores output period information which specifies an output timing of outputting an operation result obtained by the operation processing and an output continuation period of the operation result obtained by the operation processing; and
wherein the I/O device further includes:
an output period determination unit which inputs the operation result of each of the plurality of operation processing executed in parallel by the operation unit and determines the output timing and the output continuation period of the input operation result of each of the plurality of operation processing according to the output period information stored in the parameter unit, and outputs the input operation result of each of the plurality of operation processing according to the determination.

8. The I/O device according to claim 7,
wherein the parameter unit further stores operation definition information which defines operation processing to be executed using the operation result of each of the plurality of operation processing output from the output period determination unit; and
wherein the I/O device further includes a second operation unit which inputs the operation result of each of the plurality of operation processing output from the output period determination unit and executes the operation processing using the input operation result, according to the operation definition information stored in the parameter unit.

9. An I/O (Input/Output) device to be used in a programmable logic controller comprising a CPU (Central Processing Unit) device and a plurality of the I/O devices, the I/O device comprising:
an interface unit which communicates with the CPU device and also communicates with the other I/O devices, the interface unit receiving from each of the other I/O devices input information of the other I/O device and output information of the other I/O device;
a parameter unit which stores a method of operation processing, a parameter indicating an extraction condition for extracting operation data to be used for the operation processing, and output period information which specifies an output timing of outputting an operation result obtained by the operation processing and an output continuation period of the operation result obtained by the operation processing;
an operation data extraction unit which inputs the input information and the output information of each of the other I/O devices received by the interface unit and also inputs input information input into the own I/O device and output information output from the own I/O device, extracts the operation data from each of the input information and the output information of the other I/O devices which have been input and the input information and the output information of the own I/O device which have been input, according to the parameter stored in the parameter unit, and outputs the extracted operation data;
an operation unit which executes the operation processing, by using the operation data output by the operation data extraction unit and according to the method of the operation processing stored in the parameter unit; and
an output period determination unit which inputs the operation result obtained by the operation processing executed by the operation unit and determines the output timing and the output continuation period of the input operation result according to the output period information stored in the parameter unit, and outputs the input operation result according to the determination.

10. The I/O device according to claim 9,
wherein the parameter unit stores methods of a plurality of operation processing;
wherein the operation unit executes the operation processing by using the operation data output by the operation data extraction unit and according to the methods of the plurality of the operation processing stored in the parameter unit; and
wherein the output period determination unit inputs the operation result of the operation processing executed by the operation unit and determines the output timing and the output continuation period of the input operation result of the operation processing according to the output period information stored in the parameter unit, and outputs the input operation result of the operation processing according to the determination.

11. An I/O (Input/Output) device to be used in a programmable logic controller comprising a plurality of the I/O devices, the I/O device comprising:
an interface unit which communicates with the other I/O devices, the interface unit receiving from each of the other I/O devices input information input to the other I/O device and output information output from the other I/O device;
a parameter unit which stores methods of a plurality of operation processing and a parameter indicating an extraction condition for extracting operation data to be used for the operation processing;
an operation data extraction unit which inputs the input information and the output information of each of the other I/O devices received by the interface unit, extracts the operation data from each of the input information and the output information of the other I/O devices which have been obtained, according to the parameter stored in the parameter unit, and outputs the extracted operation data; and
an operation unit which executes the plurality of operation processing, by using the operation data output by the operation data extraction unit and according to the methods of the plurality of operation processing stored in the parameter unit.
